(19) United States
(12) Patent Application Publication
(10) Pub. No.: US 2013/0199681 A1
(43) Pub. Date: Aug. 8, 2013

(54) METHOD FOR DESIGNING A MOULD AND A TYRE

(71) Applicants: David Mosnier, Clermont-Ferrand Cedex 9 (FR); Antoine Paturle, Clermont-Ferrand Cedex 9 (FR)

(72) Inventors: David Mosnier, Clermont-Ferrand Cedex 9 (FR); Antoine Paturle, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/824,168

(22) PCT Filed: Oct. 6, 2011
(86) PCT No.: PCT/FR2011/052341

§ 371 Date: Apr. 23, 2013

(30) Foreign Application Priority Data
Oct. 8, 2010 (FR) 1058186

(51) Int. Cl. B60C 99/00; B29D 30/00

(52) U.S. Cl. CPC B60C 99/006; B29D 30/0061
USPC 152/154.2; 425/28.1; 264/326; 703/1

(57) ABSTRACT

The invention relates to a method for designing a curing mould for a tyre comprising at least one audible wear indicator, including the following steps (200-210):
an initial population is defined, comprising a mould model having at least one characteristic relating to the wear indicator,
a modified population is generated, comprising at least one mould model having at least one characteristic relating to the wear indicator produced by modifying at least one characteristic of at least one mould model of the initial population,
at least one performance indicator is determined for each mould model in an evaluation population comprising at least one mould model of the modified population, based on at least one characteristic of each mould model of the evaluation population,
one or more mould models of the evaluation population are selected on the basis of the performance indicator or indicators.

The present invention relates to a method for designing a mould or a tyre.

There is a known tyre of a first type comprising a tread having a sculpture. The sculpture comprises a plurality of sculpture elements such as channels, grooves or indentations. When rolling, the tyre emits a rolling noise generated by the interaction of this sculpture with the ground. If the sculpture is formed by a periodic pattern, the rolling noise comprises a howl component due to the periodic interaction of this pattern with the ground. Thus, in order to minimize the rolling noise, the tread sculpture usually comprises a plurality of separate circumferential portions. Each circumferential portion has a pattern chosen from a group of several different patterns, generally three or four in number. The sculpture is thus formed by a non-periodic arrangement of these patterns in order to prevent the howling of the tyre.

There is also a known tyre of a second type comprising a tread including audible wear indicators. These wear indicators are distributed over the tread so as to emit a characteristic noise beyond a predetermined wear threshold. The characteristic noise is, notably, a function of the predetermined distribution.

However, the incorporation of the audible wear indicators of the second type of tyre into the first type of tyre poses the problem of the compatibility of the sculpture of the first type of tyre with the predetermined distribution of the audible wear indicators of the sculpture of the second type of tyre. This is because, if a wear indicator is located in the same position as a sculpture element such as a joint between two patterns or an indentation, the wear indicator does not emit any noise, and therefore does not enable the wear to be detected. If the predetermined distribution is maintained, it is difficult, or even impossible, to design in an empirical way a tyre in which the wear indicators are not located in the same position as sculpture elements. If the wear indicators are positioned so as to avoid the positions of these sculpture elements, the predetermined distribution cannot be maintained. In this case, the wear indicators do not emit the characteristic noise and therefore do not enable the tyre wear to be detected.

The object of the invention is to provide a method for the simple design of a mould and a tyre comprising audible wear indicators.

To this end, the invention proposes a method for designing a tyre curing mould comprising at least one audible wear indicator, including the following steps A to D:

A—an initial population is defined, comprising at least one mould model having at least one characteristic relating to the wear indicator,

B—a modified population is generated, comprising at least one mould model having at least one characteristic relating to the wear indicator produced by modifying at least one characteristic of at least one mould model of the initial population,

C—at least one performance indicator is determined for each mould model in an evaluation population comprising at least one mould model of the modified population, based on at least one characteristic of each mould model of the evaluation population,

D—one or more mould models of the evaluation population are selected on the basis of the performance indicator or indicators.

The method according to the invention can be used to generate populations of mould models, preferably in an automated way, and enables a simple check to be made, by using the performance indicator, to determine whether or not the discriminating characteristics relating to the wear indicator of a selected mould model meet the predetermined performance conditions. Thus it is easy to check whether the selected mould model can be used to manufacture a tyre in which the audible wear indicator or indicators have the desired distribution and emit the noise which is characteristic of tyre wear.

The method according to the invention can use a genetic algorithm. Thus, in step B, the modification operators which are used simulate biological phenomena of combination and/or mutation of the discriminating characteristics. In a variant, the method according to the invention can use other algorithms, of the heuristic or meta-heuristic type. In these cases, during step B, the modification operators are random or semi-random.

Additionally, the method according to the invention can be used for the very rapid selection of a mould model which meets the predetermined performance conditions. This is because, owing to the use of a computer program on a conventional personal computer, a mould model can generally be selected in less than two minutes. In this case, all the steps are executed by automated means. In a variant, one or more steps are executed by automated means.

In one embodiment, each wear indicator comprises a sounding cavity shaped in such a way that, beyond a predetermined threshold of radial wear, the sounding cavity opens radially towards the outside of the tyre and is shaped so as to be closed in an airtight manner by the ground during its passage through the contact patch of the tyre on the ground.

If the tyre is worn beyond the wear threshold which is considered to be an alert threshold, one or more sounding cavities appear on the tread.

These cavities have a special shape which imparts sound-emitting properties to them; in other words, these cavities create a characteristic noise during the rolling of the worn tyre.

This is because the cavity is shaped so as to be closed in a substantially airtight manner by the ground, and therefore temporarily traps air during its passage through the contact patch of the tyre on the ground. As a result of the deformation of the tyre in the contact patch, this air trapped in the cavity is compressed and then expands suddenly on leaving the contact patch, when the tread ceases to make contact with the ground behind the tyre, thus causing the cavity to open.

This expansion of the air lasts for a few milliseconds or thereabouts, creating a distinctive noise, sometimes called a hissing or pumping noise, which is a determined, notably, by the shape and volume of the cavity.

Thus this characteristic noise, which appears only when the tyre is worn beyond a certain threshold, forms an audible wear indicator. Thus, even if the driver does not carry out a regular visual inspection of the surface condition of his tyres, he will be informed of the excessive wear of his tyres if he hears this characteristic hissing while driving.

Preferably, the shape and volume of the sounding cavity is determined in such a way that the frequency and intensity of the noise produced by the passage of the cavity through the contact patch makes this noise audible to the driver from the passenger compartment of the vehicle.

This hissing can also be detected by using one or more rolling noise detection microphones, connected to a computer adapted to detect the hissing within the rolling noise and to inform the driver of the wear of his tyres.

Since this hissing phenomenon appears only when air is compressed in the cavity and then expands while escaping from the cavity, it is important for the cavity to be closed in a substantially airtight manner by the ground during its passage through the contact patch. This because a cavity whose top was covered by the ground, but which also comprised transverse channels in fluid communication with the outside air, would not be a sounding cavity, because the air contained in it could not be compressed. This is the case, notably, with tread sculptures of prior art tyres which are generally formed by a network of channels through which the different cavities communicate with each other and with the outside air.

Similarly, a cavity whose dimensions were too large for it to be totally covered by the ground during its passage through the contact patch, for example a cavity whose length was greater than the length of the contact patch, could not form a sounding cavity for the purposes of the invention.

Optionally, each characteristic relating to the audible wear indicator is chosen from a group comprising at least one characteristic relating to the number of wear indicators, at least one characteristic relating to the total volume of the cavities, the volume of each sounding cavity being defined when the predetermined threshold of radial wear is reached, at least one characteristic relating to the circumferential distribution of the wear indicators, and at least one characteristic relating to a dimension of each wear indicator.

The group defined above can be used to define the characteristics of the wear indicators in such a way that they are audible and can be incorporated into a tyre.

The characteristic relating to the circumferential distribution of the wear indicators and the characteristic relating to the geometry of each wear indicator make it possible to ensure that each cavity is closed in a substantially airtight manner by the ground during its passage through the contact patch, and is not kept open, for example, by a sculpture element opening into the cavity or passing through the cavity.

The characteristic relating to the circumferential distribution of the wear indicators and the characteristic relating to the number of wear indicators make it possible to ensure that the characteristic noise emitted by the set of wear indicators conforms to the noise which is searched for during the wear detection.

The characteristic relating to the number of wear indicators and the characteristic relating to the total volume of the cavities make it possible to ensure that the characteristic noise can be detected. Below a predetermined volume, the characteristic noise emitted by the wear indicators does not have a spectrum level, that is to say a frequency intensity, sufficient to allow it to be distinguished in a robust manner from the parasitic elementary frequency components, corresponding for example to the noise of the engine and the transmission system associated with it.

According to other, optional, characteristics of the method according to the invention:
The characteristics relating to the circumferential distribution comprise the equal distribution of the wear indicators and a reference positioning angle of at least one wear indicator. In a variant, the wear indicators may be distributed in a predetermined irregular distribution. In this case, the characteristics relating to the circumferential distribution comprise a positioning angle of at least one wear indicator.
Each wear indicator comprises two ribs arranged at the bottom of a groove in the tyre, and the characteristic relating to the dimension comprises the thickness of each rib of each wear indicator measured in the circumferential direction.

Advantageously, the performance indicator or indicators are determined on the basis of the total volume of the sounding cavities. As the volume of the cavities increases, the spectrum level, that is to say the frequency intensity, of the characteristic noise increases. Thus, as the volume of the cavities increases, the tyre wear detection becomes more reliable. Consequently, the aim is preferably to obtain a mould for which the total volume of the cavities is maximal.

Each wear indicator comprises two ribs arranged at the bottom of a groove in the tyre, while the performance indicator or indicators are determined on the basis of at least one indicator of interpenetration between each rib and at least one predetermined region of the mould model, called the prohibited region.

The prohibited regions of the mould are such that, if ribs are located in these prohibited regions, the cavities do not act as sounding cavities, for example because of a leakage of air. Thus, the aim is preferably to obtain a mould for which the interpenetration between each rib and the prohibited regions of the mould model is minimal or even zero.

In one embodiment, a plurality of axially adjacent circumferential bands are determined in each mould model of the evaluation population, and for each band at least one indicator of interpenetration between each rib and each prohibited region is determined.

Each prohibited region of each band, and therefore of each groove, is then defined. Thus, instead of determining each interpenetration indicator for the set of axial dimensions of the tyre, each indicator is determined for each band which has a smaller axial dimension. In this embodiment, the prohibited regions have a smaller dimension in the circumferential direction, which makes the method more flexible, notably as regards the positioning of the wear indicators. Thus the speed of selection of a mould model which meets the predetermined performance conditions is improved.

Any number of circumferential bands can be defined. Depending on the mould model, each band may have a constant or fixed axial dimension. Since each band is delimited by two circumferential edges, the edges may be parallel to the circumferential direction or may extend along a zigzag or sinusoid path. Furthermore, the bands may, depending on the mould model, have the same axial dimension or a plurality of axial dimensions for any given angular position.

According to other, optional, characteristics of the method:
The mould model comprises a plurality of distinct matrices for moulding distinct circumferential portions of the tyre, and the prohibited regions comprise two end regions of each matrix. This is because the end regions are fragile, and therefore the placing of the rib casting elements of the wear indicators in the proximity of the circumferential end regions of each matrix is to be avoided.
The prohibited region comprises a region through which a blade for moulding a sculpture element passes, such that a sounding cavity located in the corresponding prohibited region of the tyre is not closed in an airtight manner by the ground during its passage through the contact patch of the tyre on the ground. This is because a sculpture element of this type would cause a leakage of air from the sounding cavity, which would prevent the compression and subsequent expansion of the air contained in this cavity. However, a region comprising a sculpture element connecting two cavities arranged in such a way that these cavities are closed substantially simultaneously by the ground in a substantially airtight manner during their passage through the contact patch of the tyre on the ground does not constitute a prohibited region.

Advantageously, the tyre comprises a legal wear indicator, and the performance indicator or indicators are determined on the basis of at least one indicator of the inclusion of at least one legal wear indicator in at least one sounding cavity.

If a legal wear indicator is included in a cavity, it may, depending on the predetermined threshold value, act as one of the ribs of the cavity, and separate the cavity into two contiguous cavities. On the one hand, this causes the destruction of the predetermined distribution of the wear indicators, while on the other hand it causes a decrease in the total volume of the cavities.

Thus, the aim is preferably to obtain a mould for which the inclusion of the legal wear indicators in the sounding cavities is minimal or even zero.

Preferably, a plurality of axially adjacent circumferential bands are determined in the mould model, and, for each band, at least one indicator of inclusion of each legal wear indicator in each sounding cavity is determined.

Thus, instead of determining each indicator of inclusion for the whole width of the tyre, each indicator is determined for each band. This makes the method more flexible, notably as regards the positioning of the wear indicators. Thus the speed of selection of a mould model which meets the predetermined performance conditions is improved.

In one embodiment, each wear indicator comprises a rib extending radially from the bottom of a circumferential groove of the tyre and arranged so as to come into contact with the ground during its passage through the contact patch of the tyre on the ground beyond a predetermined threshold of radial wear of the tyre.

The ribs do not necessarily form a cavity, but may be sufficient to cause a characteristic noise during the rolling of tyre once the wear threshold of the tyre has been reached. The inventors have hypothesized that this noise is generated by at least two distinct physical phenomena acting in a synergic manner. On the one hand, once the wear threshold has been reached, the noise is generated by the impact of the rib on the ground. On the other hand, once the wear threshold has been reached, when the tyre rolls on the ground a plug of air can be formed in the groove upstream of the rib as a result of the considerable relative speed between the tyre and the air into which the tyre penetrates. Air is thus temporarily trapped in a space between this plug and the rib when this space passes through the contact patch of the tyre on the ground. As a result of the deformation of the tyre in the contact patch, this air trapped in this space is compressed and then expands suddenly on leaving the contact patch, when the tread ceases to make contact with the ground behind the tyre.

Because of the small number of ribs, the design of the tyre and its mould is also made simpler, since each wear indicator does not form a closed cavity, and therefore it is not necessary to avoid positioning a rib in a prohibited region through which a blade passes.

The ribs are preferably arranged in such a way that, regardless of the wear on the tyre, two circumferentially successive ribs of a single groove and the groove itself delimit a space which remains open to the air when the two ribs pass through the contact patch of the tyre on the ground.

Optionally, each characteristic relating to the audible wear indicator is chosen from a group comprising at least one characteristic relating to the number of wear indicators, at least one characteristic relating to the circumferential distribution of the wear indicators, and at least one characteristic relating to a dimension of each wear indicator.

According to other, optional, characteristics of the method according to the invention:
The characteristics relating to the circumferential distribution comprise the equal distribution of the wear indicators and a reference positioning angle of at least one wear indicator.
The characteristic relating to a dimension comprises the thickness of each rib of each wear indicator measured in the circumferential direction.

Advantageously, the performance indicator or indicators are determined on the basis of at least one indicator of interpenetration between each rib and at least one predetermined region of the mould model, called the prohibited region.

The prohibited regions of the mould are such that, if ribs are located in these prohibited regions, the cavities may have moulding defects and therefore fail to generate sufficient noise when they strike the ground. Thus, the aim is preferably to obtain a mould for which the interpenetration between each rib and the prohibited regions of the mould model is minimal or even zero.

In one embodiment, a plurality of axially adjacent circumferential bands are determined in each mould model, and for each band at least one indicator of interpenetration between each rib and each prohibited region is determined.

According to another optional characteristic of the method, the mould model comprises a plurality of distinct matrices for moulding distinct circumferential portions of the tyre, and the prohibited regions comprise two end regions of each matrix.

Advantageously, the tyre comprises a legal wear indicator, and the performance indicator or indicators are determined on the basis at least one indicator of the covering of at least one legal wear indicator by a rib.

The aim is preferably to obtain a mould for which the covering of the legal wear indicators by the ribs is minimal or even zero.

Preferably, a plurality of axially adjacent circumferential bands are determined in each mould model of the evaluation population, and, for each band, at least one indicator of the covering of each legal wear indicator by each rib is determined.

Optionally, each mould model of the evaluation population is selected if each performance indicator in the model meets a predetermined performance condition associated with the performance indicator.

Advantageously, given that the tyre comprises N grooves, where N>1, and comprises a plurality of sets of wear indicators equally distributed circumferentially, the wear indicators of each set being substantially aligned axially with one another, each mould model of the evaluation population is selected if, in this model, for each set, at least a number N1 of interpenetration indicator(s) meet a predetermined performance condition associated with the interpenetration indicator with N<N1.

The expression “set of wear indicators equally distributed circumferentially” signifies that each wear indicator of a set is located at substantially the same angular distance from the wear indicators of the sets adjacent thereto, regardless of whether or not the wear indicators are arranged in the same groove. In other words, the equally distributed sets have the same angular difference when considered in pairs. If only a single set is present, this single set is considered to be equally distributed circumferentially. This is because, in this case, the adjacent sets are formed by the set itself.

For each set, it is thus possible to eliminate a maximum of N−N1 wear indicators which would show interpenetration with the prohibited regions. This improves the flexibility and speed of the method of selecting mould models whose performance indicators meet the predetermined performance conditions.

Preferably, after step A and before step B, the mould models of the initial population are classified, and part of the initial population is selected.

This avoids the necessity of proceeding to the subsequent steps with mould models which, it is assumed, cannot be used for generating mould models having indicators which meet the set of predetermined performance conditions.

Advantageously, as long as every indicator fails to meet a predetermined performance condition, steps B and C are repeated to generate a new population modified by at least one modification of at least one characteristic of at least one mould model of the evaluation population forming a new initial population.

The procedure continues by successive iteration so as to cause the discriminating characteristics of each mould model of each evaluation population to converge towards a mould model whose indicator or indicators meet the associated predetermined performance conditions.

Preferably, the mould models of the evaluation population are classified, and part of the evaluation population is selected, the selected part of the evaluation population then forming at least a part of the new initial population.

This avoids the necessity of proceeding with the subsequent iterations with mould models of the evaluation population which, it is assumed, cannot be used for generating mould models having indicators which meet the set of predetermined performance conditions.

Advantageously, each characteristic of each model of the initial population and/or of the modified population and/or of the evaluation population meets at least one predetermined constraint.

This avoids the necessity of defining or generating mould models comprising aberrant characteristics. The convergence of the method according to the invention is thus promoted.

Since the mould is the negative of the tyre, and consequently the tyre is the positive of the mould, it is also possible to use the invention by applying steps A to D to tyres comprising at least one audible wear indicator.

Thus the invention also proposes a method for designing a tyre comprising at least one audible wear indicator, including the following steps A to D:

A—an initial population is defined, comprising at least one tyre model having at least one characteristic relating to the wear indicator,

B—a modified population is generated, comprising at least one tyre model having at least one characteristic relating to the wear indicator produced by modifying at least one characteristic of at least one tyre model of the initial population,

C—at least one performance indicator is determined for each tyre model of an evaluation population comprising at least one tyre model of the modified population, based on at least one characteristic of each tyre model of the evaluation population,

D—one or more tyre models of the evaluation population are selected on the basis of the performance indicator or indicators.

The invention also relates to a computer program comprising instructions in code capable of causing the steps of one of the methods defined above to be executed when the program is run on a computer.

The invention also proposes a data recording medium comprising, in recorded form, a program as defined above. The invention proposes the provision of a program as defined above on a telecommunications network from which it is available for downloading.

The invention proposes a method of manufacturing a tyre curing mould in which a mould design method as defined above is used and the mould is made from one of the selected models.

The invention proposes a method of manufacturing a tyre curing mould in which a tyre design method as defined above is used, the mould is deduced from one of the selected tyres, and the mould is made.

The invention proposes a tyre curing mould, the mould being made by using one of the mould making methods defined above.

The invention proposes a method for manufacturing a tyre, in which a mould is made by using one of the mould making methods defined above, and a green blank is cured in the mould.

The invention proposes a tyre, the tyre being manufactured by using a tyre manufacturing method as defined above.

The invention will be more clearly understood from the following description which is provided solely by way of example and which refers to the drawings, in which:

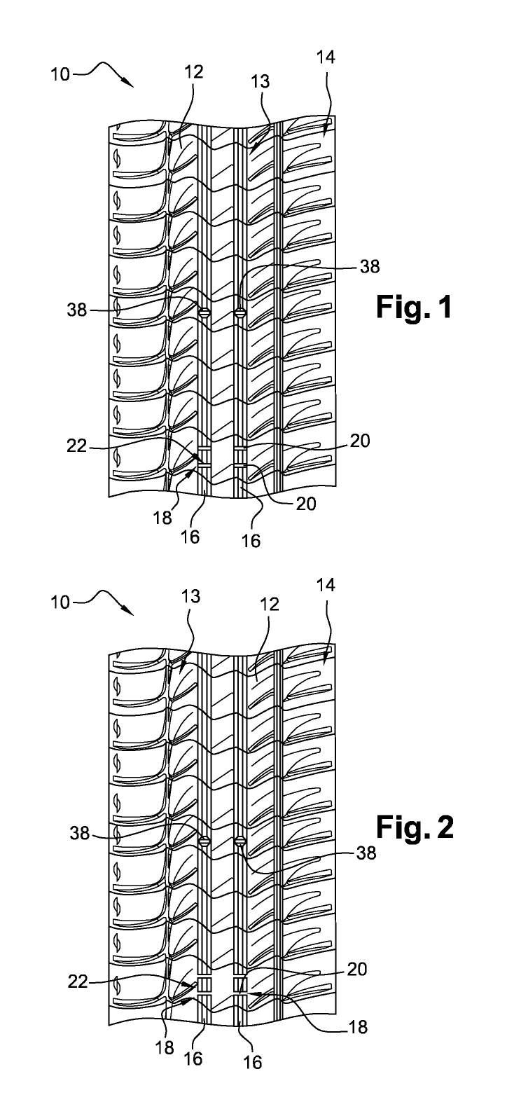

FIG. 1 shows a tread of a new tyre according to a first embodiment, comprising audible wear indicators;

FIG. 2 shows a tread of the tyre of FIG. 1, in a worn condition;

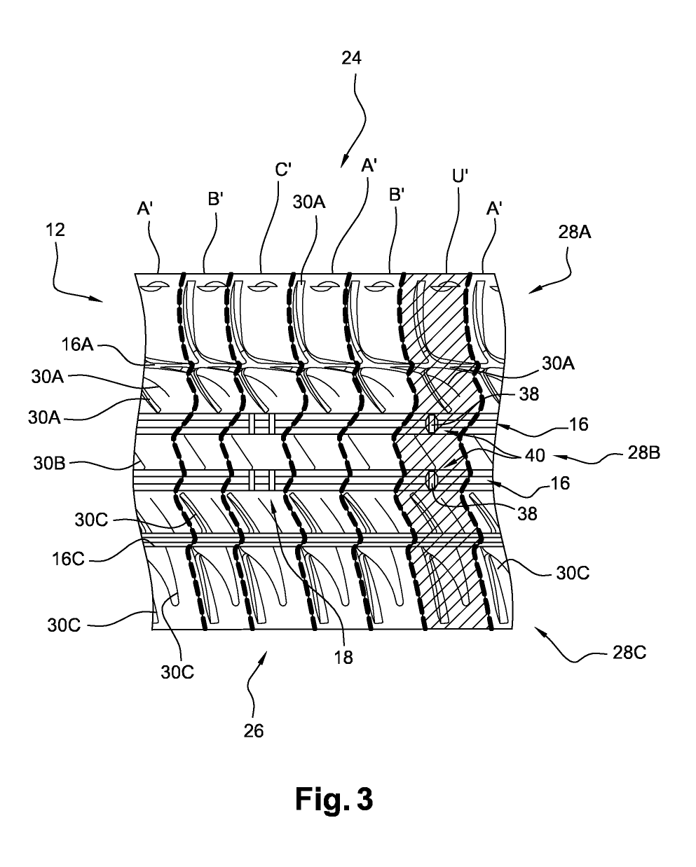

FIG. 3 shows details of the tread of the tyre of FIG. 1;

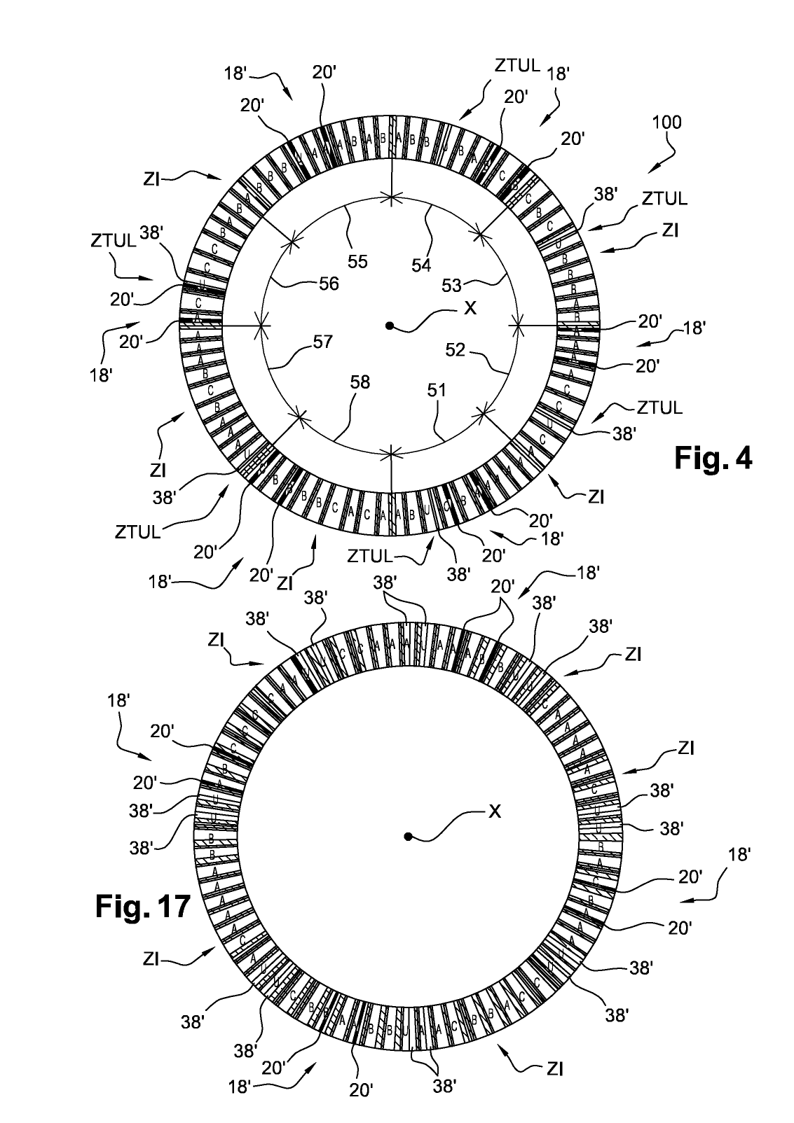

FIG. 4 shows a curing mould for the tyre of FIG. 1, designed using the method according to a first embodiment of the invention;

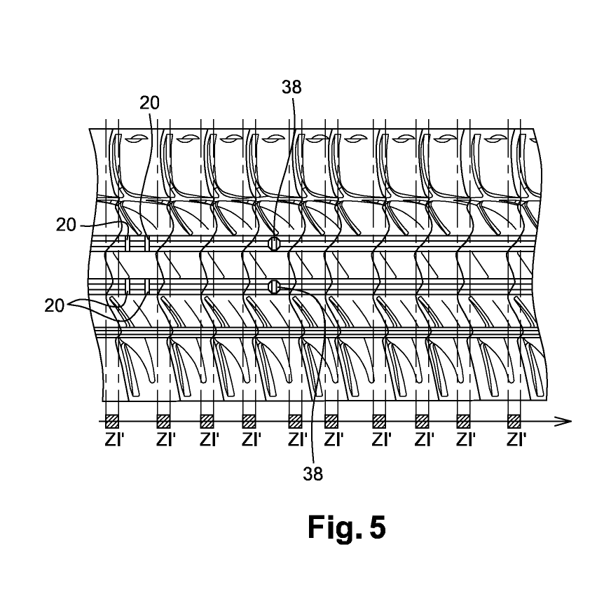

FIG. 5 is a view similar to that of FIG. 3, showing prohibited regions for the placing of the audible wear indicators;

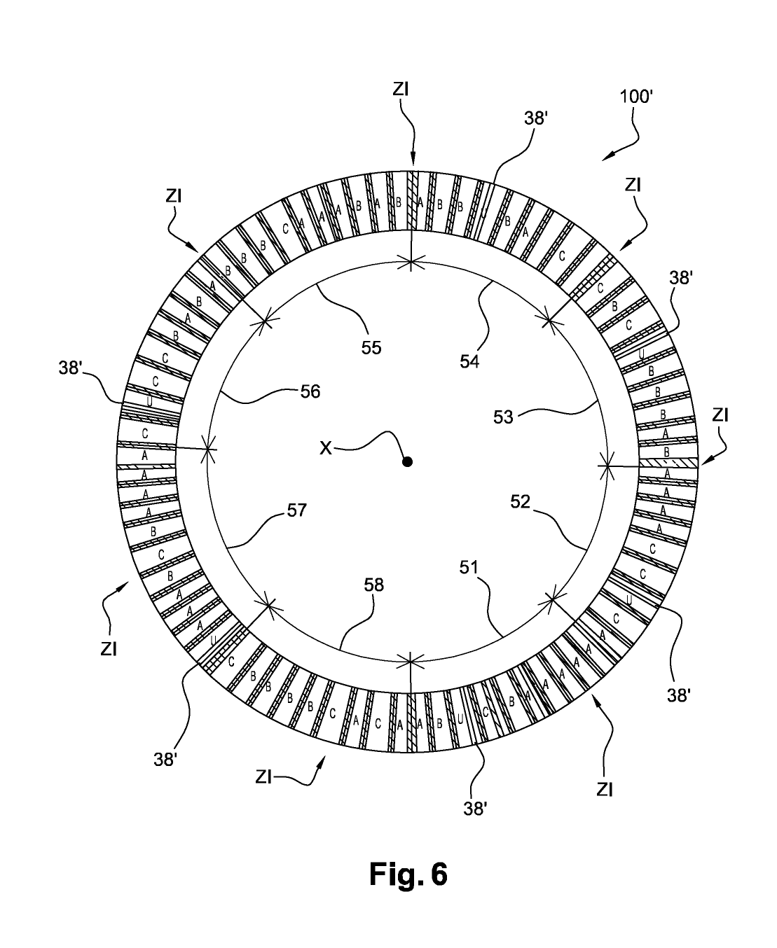

FIG. 6 shows a curing mould for the tyre of FIG. 1 without audible wear indicators;

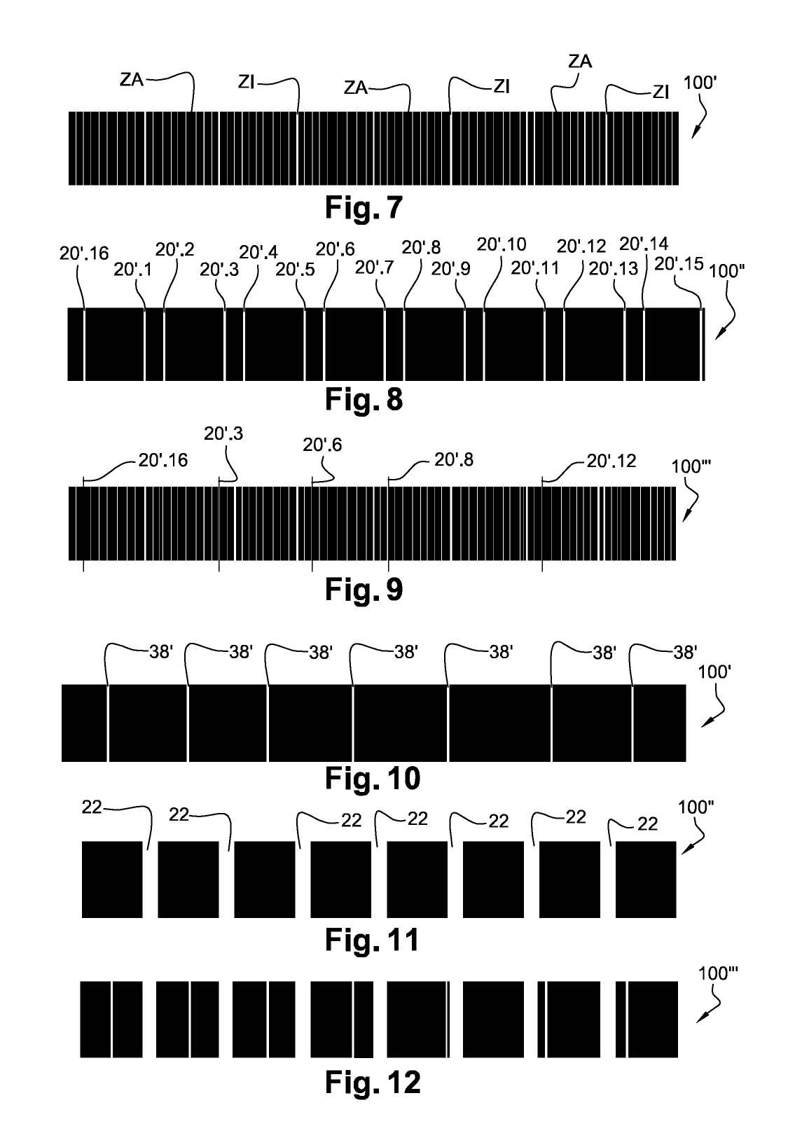

FIGS. 7 to 9 show prohibited regions which are incompatible with the positioning of audible wear indicators in the tyre of FIG. 1;

FIGS. 10 to 12 show regions for the positioning of legal wear indicators which are incompatible with the positioning of audible wear indicators in the tyre of FIG. 1;

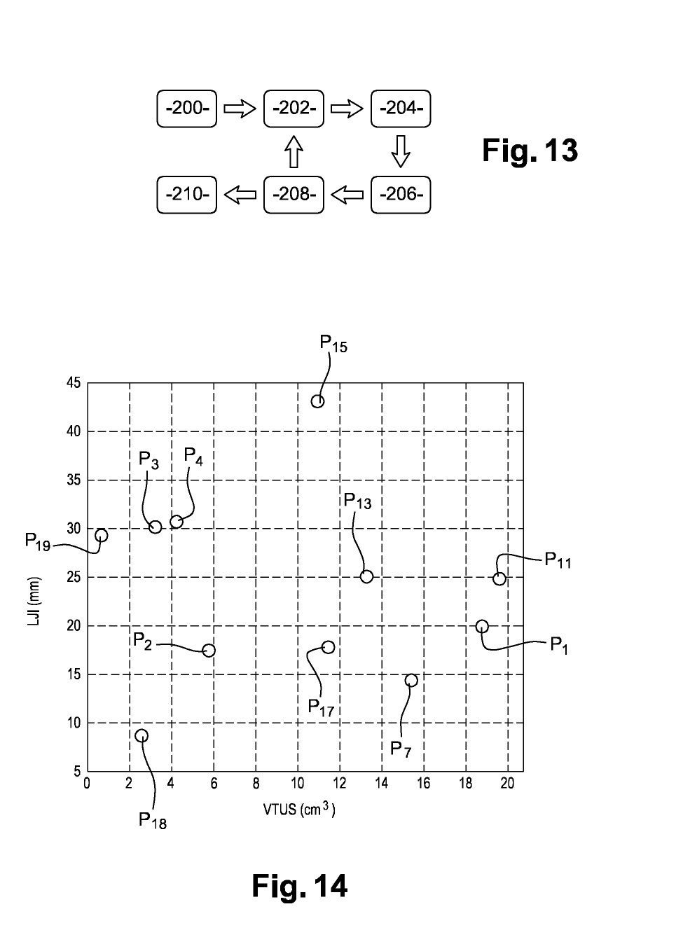

FIG. 13 is a schematic illustration of the method according to the first embodiment of the invention;

FIG. 14 shows a Pareto diagram of a plurality of moulds of an initial population;

FIG. 15 is a schematic illustration of a step of modifying the moulds of the initial population;

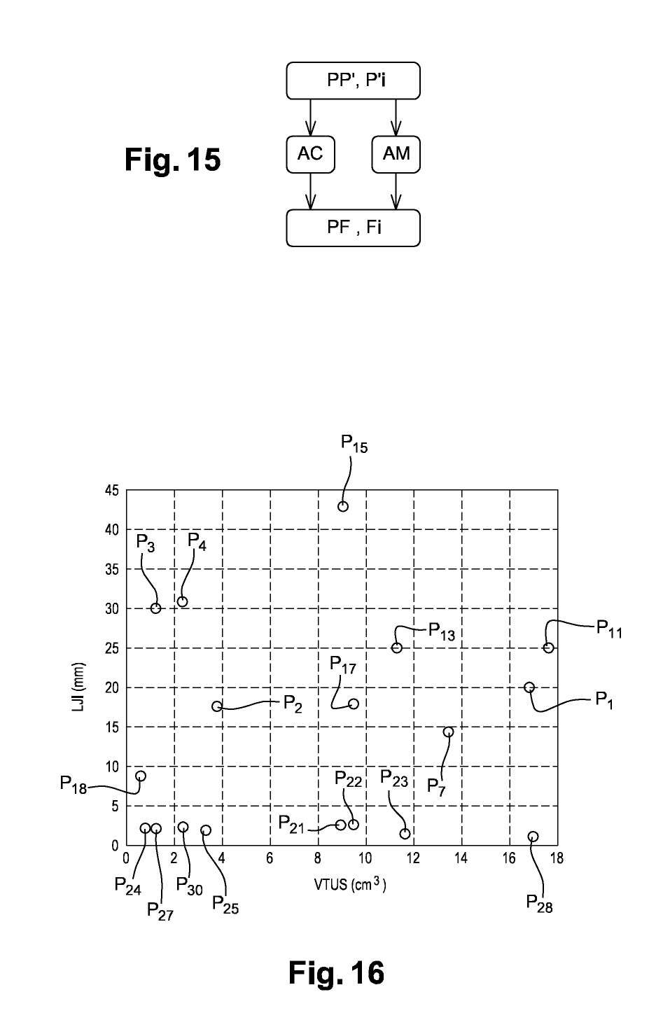

FIG. 16 shows a Pareto diagram of a plurality of moulds of an evaluation population;

FIG. 17 shows a mould designed using the method according to a first embodiment of the invention;

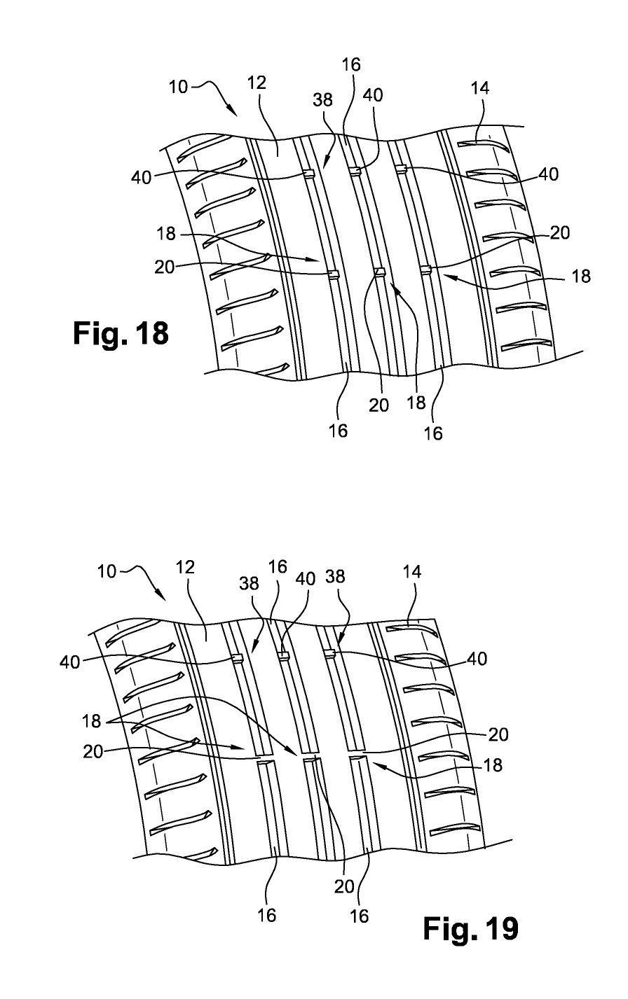

FIG. 18 shows a tread of a new tyre according to a second embodiment, comprising audible wear indicators;

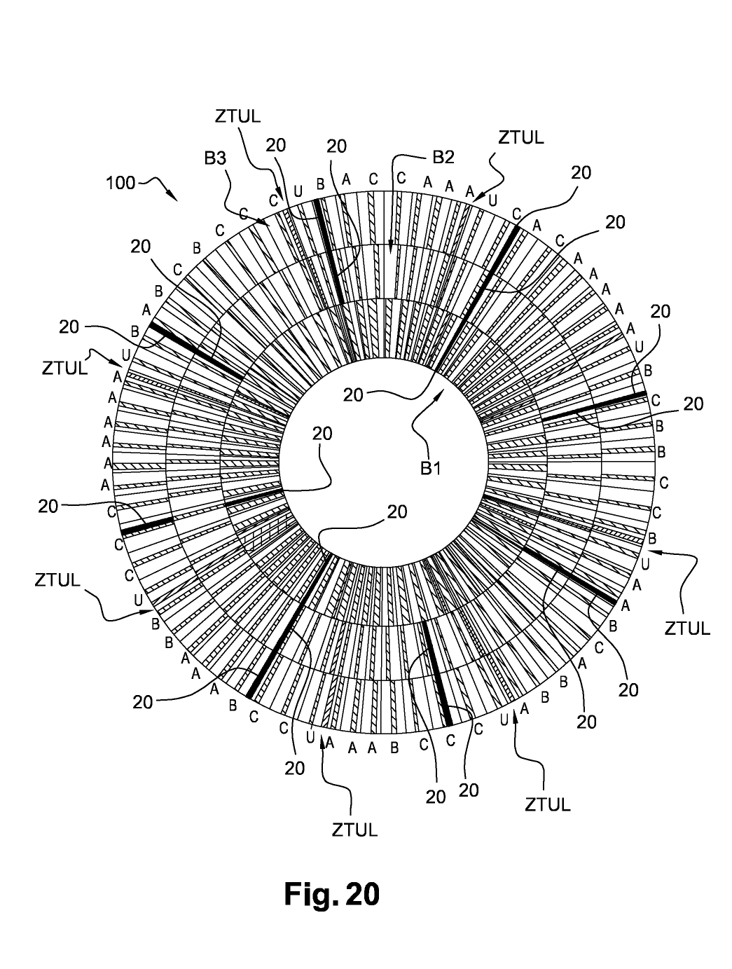

FIG. 19 shows a tread of the tyre of FIG. 18, in a worn condition;

FIG. 20 shows a curing mould for the tyre of FIG. 18, designed using the method according to a second embodiment of the invention;

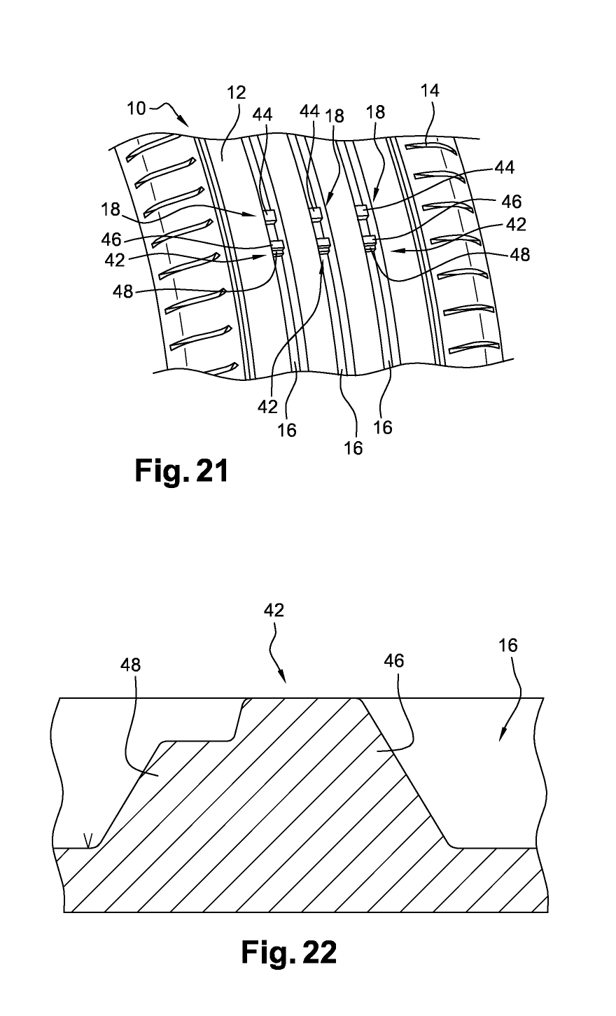

FIG. 21 shows a tread of a new tyre according to a third embodiment, comprising audible wear indicators;

FIG. 22 is a view in axial section taken in a plane passing through a groove of a tread of the tyre of FIG. 21, in a worn condition;

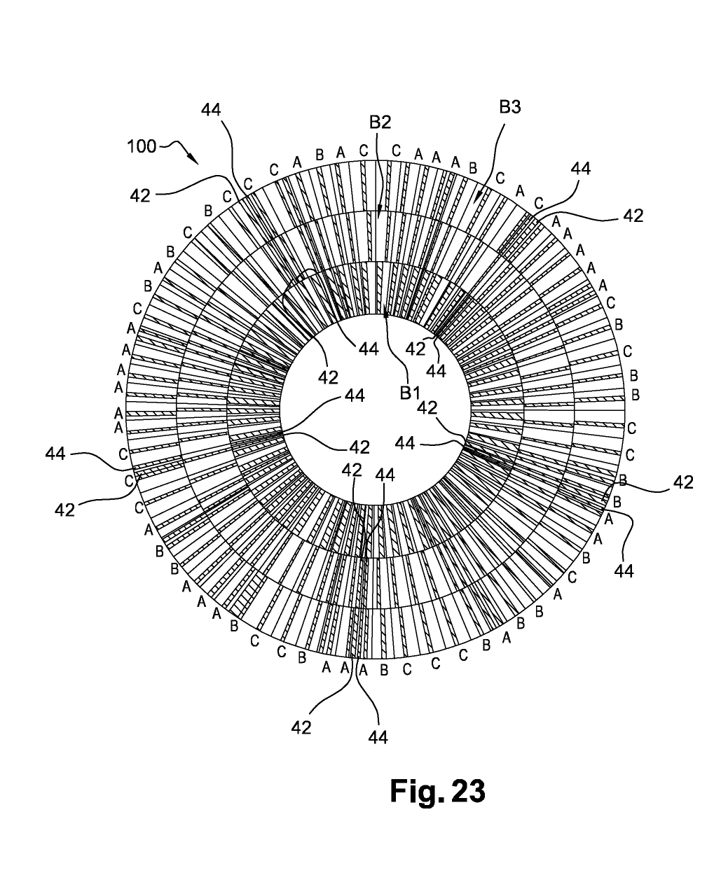

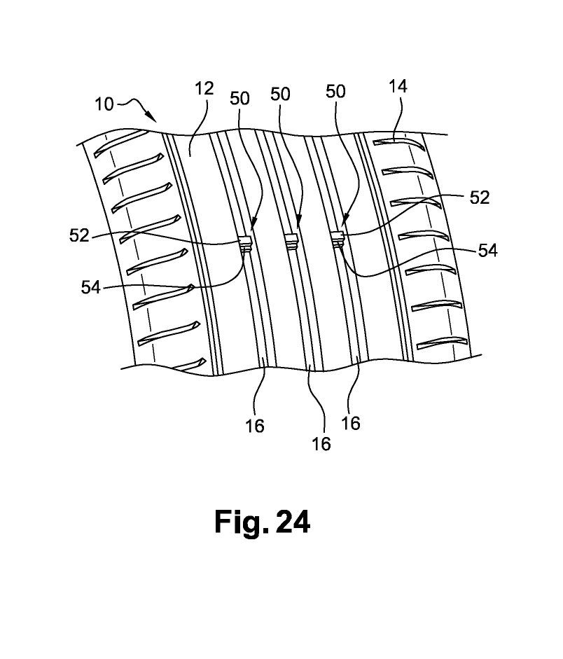

FIG. 23 shows a curing mould for the tyre of FIG. 21, designed using the method according to a third embodiment of the invention; and

FIG. 24 shows a tread of a new tyre according to a fourth embodiment, comprising audible wear indicators.

FIGS. 1 and 2 show a tyre according to a first embodiment, indicated by the general reference 10. The tyre 10 comprises a substantially cylindrical tread 12 whose outer surface 13 is provided with sculpture elements 14. In particular, the tread 12 comprises two parallel circumferential grooves 16, formed in the surface of the tyre, and having a predetermined depth when the tyre 10 is new. For example, the depth of these grooves 16 is about 8 mm for a passenger vehicle tyre and 14 to 25 mm for a heavy goods vehicle tyre. The tyre 10 further comprises audible wear indicators 18.

Each audible wear indicator 18 comprises two ribs 20 arranged at the bottom of the grooves 16 and extending transversely with respect to the grooves 16. The height of the ribs 20 is predetermined when the tyre is new. For example, the height of these ribs is substantially equal to 1.6 mm. Each groove 16 comprises four wear indicators 18 equally distributed circumferentially along each groove 16, two wear indicators 18 of each groove being substantially axially aligned. Two substantially axially aligned wear indicators form a set of wear indicators. In all, therefore, the tread 12 has four sets of two audible wear indicators 18, making a total of eight wear indicators 18. In a variant, the tyre may have from one to 16 sets of wear indicators 18.

The volume defined by a groove 16 and two neighbouring ribs 20 forms a cavity 22 opening radially towards the outside of the tyre 10.

When the tyre 10 is new, as shown in FIG. 1, the height of the ribs 20 is less than the depth of the grooves 16, and therefore two neighbouring cavities 22 comprise a fluid communication passage located above the ribs 20. Thus, even when the tread 12 is in contact with the ground, the ground does not completely seal the cavities 22, because the tops of the ribs 20 are not in contact with the ground. In this case, the various neighbouring cavities 22 are in fluid communication with one another through a constriction channel delimited by the tops of the ribs and the ground covering the cavities 22.

FIG. 2 shows the tyre 10 of FIG. 1 in a used condition, in which the tread 12 has been progressively worn down so as to lose several millimetres of its radial thickness, amounting to about 5 mm.

In this case, the wear on the tread 12 of the tyre 10 shown in FIG. 2 is about 6 millimetres, in other words greater than the distance separating the tops of the ribs 20 from the surface 13 when the tyre is new. Because of this pronounced wear, the tops of the ribs 20 are at the same level as the surface 13. Thus the opening of each cavity 22 is defined by a substantially flat contour formed on the tread 12, and the cavities 22 are distinct and separate from one another.

Each cavity 22 has a length of about 10 to 50 millimetres, corresponding to the circumferential separation between two adjacent ribs 20, and a depth less than or equal to the initial height of the rib 18.

Thus the total volume of the cavities 22 is greater than or equal to 2 cm³, or preferably 5 cm³.

Because the opening of each cavity 20 is defined by a substantially flat contour, it can be sealed completely and hermetically by flat smooth ground during rolling. In other words, when the tyre 10 is worn, each cavity 22 is shaped so as to be closed in a substantially airtight manner by the ground during its passage through the contact patch of the tyre 10 on the ground.

A cavity 20 of this type formed on the surface of the tread 10 of a tyre which, on the one hand, opens radially towards the outside of the tyre and which, on the other hand, is shaped so as to be closed hermetically during its passage through the contact patch, is called a “sounding cavity”.

In a tyre according to the first embodiment of the invention, sounding cavities of this type appear only when the tyre is worn beyond a predetermined threshold of radial wear, and do not exist below this threshold, notably when the tyre is new.

When the tyre rolls, a given sounding cavity 22 occupies, in succession, an upstream position relative to the contact patch of the tyre on the ground in which it is open, then a position in the contact patch in which it is closed because it is covered by the ground, and finally a downstream position relative to the contact patch of the tyre on the ground, in which it is open once again and in which it is no longer covered by the ground.

In other words, the rotation of the tyre causes, for a given cavity, the admission of air into the cavity, the compression of the air contained in the cavity when the latter is closed by the ground in the contact patch, and then the expansion of the air contained in the cavity when the latter is opened by the separation of the tread 12 from the ground.

This succession of steps of admission, compression and expansion gives rise to the characteristic noise, sometimes called a hissing or pumping noise, resulting from the expansion of the compressed air contained in the cavity.

The problem which the invention proposes to resolve is that of designing a curing mould for a tyre having audible wear indicators, such as the wear indicators of the tyre of FIGS. 1 and 2. Clearly, the design method is not limited to the design of a curing mould for the tyres of FIGS. 1 and 2.

FIG. 3 shows an enlarged view of the tread 12 of the tyre of FIGS. 1 and 2. The tread 12 is delimited by two shoulders 24, 26.

The shoulders 24, 26, together with the grooves 16, delimit circumferential bands of rubber 28A-28C. In this case, the band 28A is delimited axially by the shoulder 24 and one groove 16, the band 28B is delimited by the grooves 16, and the band 28C is delimited by the other groove 16 and the shoulder 26. Each band 28A, 28B, 28C has respective sculpture elements 30A, 30B, 30C.

The sculpture elements 30A, 30C each have a respective secondary groove 16A, 16C extending in a generally circumferential direction, formed in the rubber of the tread 12. The sculpture elements 30A, 30C each have respective sculpture elements extending in a generally axial direction from each secondary groove 16A, 16C.

The tread also has legal wear indicators 38 arranged at the bottom of each groove 16A, 16C. Each legal wear indicator 38 comprises a rib 40 whose height is less than the depth of each groove 16A, 16C when the tyre 10 is new. Thus, when the tread 12 is worn beyond a predetermined threshold, called the legal threshold, corresponding to grooves having a depth of 1.6 mm, the ribs 40 become flush with the surface of the tread 12. Consequently the wear indicators 38 are also called legal wear indicators.

By way of illustration, the tread 12 of FIG. 3 is divided into circumferential portions. Each circumferential portion has a pattern formed by sculpture elements. Each sculpture element pattern belongs to a group of at least three different patterns. In this case, the group is composed of the patterns A, B′, C′ and U′. In FIG. 3, two circumferentially adjacent portions are delimited by a broken line extending between the shoulders 24, 26. The circumferential portions follow each other circumferentially in a predetermined order for the purpose of avoiding the howl phenomenon mentioned above.

A curing mould 100 for the tyre 10 is shown schematically in FIG. 4. The curing mould 100 is substantially a solid of revolution about an axis X, and has a plurality of distinct radial sectors S1-S8, distributed circumferentially about the axis X over substantially equal angular widths. In this case, the mould 100 comprises eight sectors S1-S8. Each sector S1-S8 comprises a plurality of matrices for moulding the tread 12. The mould matrices of each sector S1-S8 are selected from a group of at least four distinct matrices. In this case, the group is composed of type A, B, C and U matrices. Each matrix A, B, C and U can be used to mould each circumferential portion A, B′, C′ and U′ respectively.

The matrices A, B and C carry elements for moulding the patterns of the circumferential portions A′, B′ and C′ respectively of the tyre 10. The matrix U carries elements for moulding the circumferential portion U, comprising elements 38′ for moulding the legal wear indicators 38. Each matrix A, B, C, and U comprises two circumferential end portions for forming joints with the two circumferentially adjacent matrices. In FIG. 4, the joint between two matrices is shown as a solid line. Some matrices comprise elements 18′ for moulding the wear indicators 18, comprising elements 20′ for moulding each rib 20.

The mould 100 comprises predetermined regions ZI, called prohibited regions, in which the elements 18′ for moulding the wear indicators 18, notably the elements 20′ for moulding the ribs 20, must not be positioned, for the reasons stated above. Each matrix of the mould 100 comprises two prohibited regions ZI, which in this case are the two end regions of the matrix. Each prohibited end region of each matrix has a circumferential length substantially equal to 2 mm. Thus, at the junction of two matrices, the prohibited region has a circumferential length substantially equal to 4 mm. In FIG. 4, the regions ZI are greyed. FIG. 5 shows the prohibited regions ZI′ of the tyre 10, corresponding to the regions ZI of the mould.

In a variant, the prohibited regions ZI also comprise a region through which a blade for moulding a sculpture element passes, such that a cavity located in said region is not closed in an airtight manner by the ground during its passage through the contact patch of the tyre on the ground.

The mould 100 also comprises regions ZTUL comprising elements 38′ for moulding the wear indicators 38, in which, again, the elements 18′ for moulding the wear indicators 18, notably the elements 20′ for moulding the ribs 20, must not be positioned, for the reasons stated above.

The invention proposes that the mould be designed while ensuring that the moulding elements 18′ are not located in a prohibited region ZI and that no wear indicator 38 is located in a cavity 22 of the tyre manufactured by the mould.

FIG. 6 shows a mould 100′, identical to the mould 100 of FIG. 4, but without the elements 18 for moulding the wear indicators 18 of the tyre 10.

FIG. 7 is a developed schematic illustration of the mould 100′ in which the white portions indicate the positions of the prohibited regions ZI. Conversely, the black regions indicate the positions of authorized regions ZA where elements 18′ for moulding wear indicators 18 can be added. FIG. 8 is a developed schematic illustration of an imaginary mould 100″ which includes only the elements 18′ for moulding the wear indicators 18. In this illustration, the white portions indicate the positions of the elements 20′ for moulding the ribs 20. In this case, elements 20′.1 to 20′.16 are identified. Finally, FIG. 9 shows a mould 100′″ formed by the superimposition of the moulds 100′ and 100″. It should be noted that the elements 20′ for the ribs 20′.3, 20′.6, 20′.8, 20′.12 and 20′.16 are superimposed on certain prohibited regions ZI, making the manufacture of the tyre 10 impossible with the mould 100′″.

FIG. 10 is a developed schematic illustration of the mould 100′ in which the white portions indicate the positions of the elements 38′ for moulding the wear indicators 38. FIG. 11 is a developed schematic illustration of the imaginary mould 100″ in which the white portions indicate the positions of the elements 18′ for moulding the wear indicators 18, in this case the cavities 22. Finally, FIG. 12 shows the superimposition of the moulds 100′ and 100″. It should be noted that all the white portions of the mould 100′ are superimposed on the black portions of the mould 100″. Thus the mould 100′″ meets the condition that no wear indicator 38 must be located in a cavity 22.

A description will now be given of a method for designing the mould of FIG. 4 according to a first embodiment of the invention, illustrated in a general manner in FIG. 13.

Step A: Listing an Initial Population

In a first step 200, an initial population PP1 is listed, comprising a predetermined number of individuals, which in this case are mould models Pi. Each mould model Pi of the initial population PP1 is characterized by discriminating characteristics.

This initial population PP1 is called the parent population. The parent population PP1 is generated randomly and comprises twenty mould models. The discriminating characteristics comprise a characteristic relating to the number of wear indicators, in this case the total number NTUS of sets of wear indicators 18, a characteristic relating to the total volume of sounding cavities, in this case the total volume VTUS of the sounding cavities 22, characteristics relating to the circumferential distribution of the wear indicators, in this case the equal distribution of the sets of wear indicators 18 and a reference position αTUS of one of the sets of wear indicators 18, and finally a characteristic relating to a dimension of each wear indicator, in this case the thickness ETUS in the circumferential direction of each rib 20 delimiting the sounding cavities 22.

Each discriminating characteristic meets at least one predetermined constraint defined by the desired characteristic noise. In the example, each discriminating characteristic belongs to a constraint range. In this case, NTUS ε [6; 9], VTUS ε [0 cm³; 20 cm³], αTUS ε [0°; 360°] and ETUS ε [4 mm; 6 mm].

Table 1 below shows the “genotype” of each mould model Pi, that is to say the discriminating characteristics of each mould model Pi of the parent population PP1.

TABLE 1
discriminating characteristics of each
mould model Pi of the population PP1

| Individual | NTUS | VTUS (cm³) | αTUS (°) | ETUS (mm) |
|---|---|---|---|---|
| P1 | 8 | 18.8 | 313.1 | 4.9 |
| P2 | 7 | 5.8 | 246 | 4.4 |
| P3 | 8 | 3.2 | 347.5 | 5.6 |
| P4 | 8 | 4.3 | 167.2 | 5.3 |
| P5 | 6 | 7.9 | 208.1 | 5.7 |
| P6 | 6 | 6.5 | 324.5 | 4.2 |
| P7 | 7 | 15.4 | 181.4 | 4.9 |
| P8 | 6 | 14.8 | 264.8 | 4.7 |
| P9 | 7 | 9.1 | 277 | 4.5 |
| P10 | 7 | 1.7 | 75.8 | 5.9 |
| P11 | 9 | 19.6 | 90.9 | 4 |
| P12 | 8 | 16.1 | 295.2 | 4.5 |
| P13 | 7 | 13.3 | 131.2 | 5.4 |
| P14 | 9 | 8.6 | 18.5 | 5.1 |
| P15 | 8 | 11 | 229.1 | 5.9 |
| P16 | 7 | 17.1 | 63.3 | 5.3 |
| P17 | 7 | 11.5 | 52 | 5.1 |
| P18 | 9 | 2.6 | 12.4 | 4.2 |
| P19 | 8 | 0.7 | 151.5 | 5.6 |
| P20 | 8 | 12.3 | 109.6 | 4.6 |

In a step 202, the mould models Pi are classified, and the best mould models Pi of the population PP1 are selected. For this purpose, one or more indicators, called performance indicators, of the parent population PP1 are determined on the basis of the discriminating characteristics of each mould model Pi of the population PP1.

In this case, the performance indicators comprise the total volume of the sounding cavities VTUS, an indicator of the interpenetration between each rib 20 and at least one prohibited region ZI, and an indicator of the inclusion of at least one legal wear indicator in at least one sounding cavity. The interpenetration indicator comprises an overlap length LJI between the length of each sounding cavity 22 and each prohibited region ZI. In a variant, the interpenetration indicator comprises a volume VJI substantially equal to the total volume of the sounding cavities 22 located in each prohibited region ZI. The inclusion indicator comprises a length of inclusion LTUL of a wear indicator 38 in a sounding cavity 22. In a variant, the second interpenetration indicator comprises a volume VTUL substantially equal to the total volume of the wear indicators 38 located in each sounding cavity 20. In another variant, the performance indicators also comprise the number NTUS of sets of wear indicators 18.

The aim is to generate mould models for which the indicators VTUS, LJI=0 and LTUL meet the set of predetermined performance conditions. In this case, the predetermined performance conditions are VTUS ε [0 cm3; 20 cm3], LJI=0 and LTUL=0.

The first and second interpenetration indicators are concatenated with the data of Table 1 in Table 2 below.

TABLE 2
discriminating characteristics and performance indicators of each mould
model Pi of the population PP1

| Individual | NTUS | VTUS (cm³) | αTUS(°) | ETUS (mm) | VTUS (cm³) | LJI (mm) | LTUL (mm) |
|---|---|---|---|---|---|---|---|
| P1 | 8 | 18.8 | 313.1 | 4.9 | 18.8 | 19.9 | 0 |
| P2 | 7 | 5.8 | 246 | 4.4 | 5.8 | 17.4 | 0 |
| P3 | 8 | 3.2 | 347.5 | 5.6 | 3.2 | 30.2 | 0 |
| P4 | 8 | 4.3 | 167.2 | 5.3 | 4.3 | 30.7 | 0 |
| P5 | 6 | 7.9 | 208.1 | 5.7 | 7.9 | 26 | 2.2 |
| P6 | 6 | 6.5 | 324.5 | 4.2 | 6.5 | 12.1 | 8.2 |
| P7 | 7 | 15.4 | 181.4 | 4.9 | 15.4 | 14.3 | 0 |
| P8 | 6 | 14.8 | 264.8 | 4.7 | 14.8 | 9.4 | 8.2 |
| P9 | 7 | 9.1 | 277 | 4.5 | 9.1 | 12.7 | 11.2 |
| P10 | 7 | 1.7 | 75.8 | 5.9 | 1.7 | 10.7 | 5 |
| P11 | 9 | 19.6 | 90.9 | 4 | 19.6 | 24.8 | 0 |
| P12 | 8 | 16.1 | 295.2 | 4.5 | 16.1 | 23.4 | 15.1 |
| P13 | 7 | 13.3 | 131.2 | 5.4 | 13.3 | 25 | 0 |
| P14 | 9 | 8.6 | 18.5 | 5.1 | 8.6 | 28.6 | 3.7 |
| P15 | 8 | 11 | 229.1 | 5.9 | 11 | 42.9 | 0 |
| P16 | 7 | 17.1 | 63.3 | 5.3 | 17.1 | 28.2 | 20.5 |
| P17 | 7 | 11.5 | 52 | 5.1 | 11.5 | 17.7 | 0 |
| P18 | 9 | 2.6 | 12.4 | 4.2 | 2.6 | 8.6 | 0 |
| P19 | 8 | 0.7 | 151.5 | 5.6 | 0.7 | 29.2 | 0 |
| P20 | 8 | 12.3 | 109.6 | 4.6 | 12.3 | 6.8 | 4.1 |

In a first classification sub-step, each mould model Pi of the population PP1 is classified. Thus each mould model Pi is classified as a function of VTUS and of the first indicator LJI. FIG. 14 shows the mould models Pi belonging to the plane VTUS=[0; 20], LJI=[50 cm³; 450 cm³] and LTUL=0 in a Pareto diagram with VTUS shown on the horizontal axis and LJI on the vertical axis. The mould models Pi are then classified according to PO ranks of the Pareto optimality problem. Thus the mould models Pi corresponding to the set of solutions of the Pareto optimality problem are selected; in other words the mould models Pi* are selected such that there is no other mould model Pi such that VTUS(Pi)≦VTUS(Pi*) and LJI(Pi)≧LJI(Pi*) and such that there is no VTUS or LJI such that VTUS(Pi)<VTUS(Pi*) and LJI(Pi)>LJI(Pi*). The selected mould models are mould models forming solutions to the Pareto optimality problem with a PO rank of 1. In this case, they are the mould models P11, P1, P7, P18, P8 and P20. The mould models having the PO rank of 1 are then withdrawn from the population PP1, and the remaining mould models Pi corresponding to the set of solutions to the Pareto optimality problem are selected. The selected mould models are mould models forming solutions to the Pareto optimality problem with a PO rank of 2. In this case, they are the mould models P13, P17, P2, P16, P12, P9, P6 and P10. Finally, the mould models having the PO ranks of 1 and 2 are withdrawn from the population, and the remaining mould models Pi corresponding to the set of solutions to the Pareto optimality problem are selected. The selected mould models are mould models forming solutions to the Pareto optimality problem with a PO rank of 3. In this case, they are the mould models P15, P4, P3, P19, P5 and P14. As a general rule, the steps of selection and withdrawal are reiterated as many times as necessary, so as to assign a PO rank to each of the mould models Pi.

In a second classification sub-step, a modified rank, Rank*, is determined from the PO rank and from performance conditions not met by each of the mould models Pi. In this case, for the mould models Pi for which the indicator LTUL=0, the highest PO rank plus one, in this case 4, is added to the PO rank of the mould model Pi. For the mould models Pi for which the second indicator LTUL≠0, the corresponding Rank* for a mould model Pi having the same PO rank but for which LTUL=0, together with the highest PO rank plus one, is added to the PO rank of the mould model Pi, the amounts in this case being 5+4=9 for a mould model Pi with a PO rank of 1, 6+4 for a mould model Pi with a PO rank of 2, and 7+4 for a mould model Pi with a PO rank of 3.

The PO rank and Rank* are concatenated with the data of Table 2 in Table 3 below.

TABLE 3
discriminating characteristics, performance indicators, PO rank and
Rank* of each mould model Pi of the parent population PP1.

| Individual | NTUS | VTUS (cm³) | αTUS (°) | ETUS (mm) | VTUS (cm³) | LJI (mm) | LTUL (mm) | PO rank | Rank* |
|---|---|---|---|---|---|---|---|---|---|
| P11 | 9 | 19.6 | 90.9 | 4 | 19.6 | 24.8 | 0 | 1 | 5 |
| P1 | 8 | 18.8 | 313.1 | 4.9 | 18.8 | 19.9 | 0 | 1 | 5 |
| P7 | 7 | 15.4 | 181.4 | 4.9 | 15.4 | 14.3 | 0 | 1 | 5 |
| P18 | 9 | 2.6 | 12.4 | 4.2 | 2.6 | 8.6 | 0 | 1 | 5 |
| P13 | 7 | 13.3 | 131.2 | 5.4 | 13.3 | 25 | 0 | 2 | 6 |
| P17 | 7 | 11.5 | 52 | 5.1 | 11.5 | 17.7 | 0 | 2 | 6 |
| P2 | 7 | 5.8 | 246 | 4.4 | 5.8 | 17.4 | 0 | 2 | 6 |
| P15 | 8 | 11 | 229.1 | 5.9 | 11 | 42.9 | 0 | 3 | 7 |
| P4 | 8 | 4.3 | 167.2 | 5.3 | 4.3 | 30.7 | 0 | 3 | 7 |
| P3 | 8 | 3.2 | 347.5 | 5.6 | 3.2 | 30.2 | 0 | 3 | 7 |
| P19 | 8 | 0.7 | 151.5 | 5.6 | 0.7 | 29.2 | 0 | 3 | 7 |
| P8 | 6 | 14.8 | 264.8 | 4.7 | 14.8 | 9.4 | 8.2 | 1 | 9 |
| P20 | 8 | 12.3 | 109.6 | 4.6 | 12.3 | 6.8 | 4.1 | 1 | 9 |
| P16 | 7 | 17.1 | 63.3 | 5.3 | 17.1 | 28.2 | 20.5 | 2 | 11 |
| P12 | 8 | 16.1 | 295.2 | 4.5 | 16.1 | 23.4 | 15.1 | 2 | 11 |
| P9 | 7 | 9.1 | 277 | 4.5 | 9.1 | 12.7 | 11.2 | 2 | 11 |
| P6 | 6 | 6.5 | 324.5 | 4.2 | 6.5 | 12.1 | 8.2 | 2 | 11 |
| P10 | 7 | 1.7 | 75.8 | 5.9 | 1.7 | 10.7 | 5.0 | 2 | 11 |
| P14 | 9 | 8.6 | 18.5 | 5.1 | 8.6 | 28.6 | 3.7 | 3 | 12 |
| P5 | 6 | 7.9 | 208.1 | 5.7 | 7.9 | 26 | 2.2 | 3 | 12 |

In a third classification sub-step, some of the mould models Pi of the parent population PP1 are then classified. In this case, half of the mould models Pi of the parent population PP1 having the lowest performance indicator Rank*, in other words the mould models P11, P1, P7, P18, P13, P17, P2, P15, P4 and P3, are selected. These mould models Pi form a selected parent population PP1′ comprising the moulds P′11=P11, P′1=P1, P′7=P7, P′18=P18, P′13=P13, P′17=P17, P′2=P2, P′4=P4 and P′3=P3.

Step B: Generating a Modified Population

In a subsequent step 204, a modified population PF1 of mould models Fi with i ε [0; 20] is generated from the mould models Pi′ of the selected parent population PP1′ obtained in the preceding optional selection step. This step 204 is shown in FIG. 15. The modified population PF1 is called the child population. Each mould model Fi of the modified population PF is characterized by the same discriminating characteristics as the parent population PP1′. These discriminating characteristics are obtained by modifying at least one discriminating characteristic of at least one mould model Pi′ of the parent population PP1′.

In the described embodiment, some of the mould models Fi of the population PF1 are generated by means of a combination algorithm AC for combing at least one discriminating characteristic of two mould models Fi of the population PP1′ and some other mould models Fi of the population PF1 are generated by means of a mutation algorithm AM for mutating a mould model P′i of the population PP1′. In a variant, all the mould models Fi of the population Fi are generated by means of a combination algorithm. In another variant, all the mould models Fi of the population Fi are generated by means of a mutation algorithm.

The combination algorithm will now be described. In this case, it is an SBX (Simulated Binary Crossover) algorithm. Two mould models P′i, P′j of the parent population PP1′ are selected. The selection is carried out in a random manner. In a variant, the mould model P′i is selected randomly and the mould model P′j is selected according to predetermined parental selection criteria. In another variant, the mould models P′i, P′j are selected according to predetermined parental selection criteria. A random root u ε [0; 1] is then generated. A crossover operator β is then calculated. If u≦0.5, then

$$β = {( 2 u )}^{\frac{1}{{η}_{c} + 1}} ; otherwise , β = {( \frac{1}{2 ( 1 - u )} )}^{\frac{1}{{η}_{c} + 1}}$$

where η_{c}=20, η_{c} being the distribution index. For each discriminating characteristic, H=NTUS, VTUS, αTUS or ETUS, and two child mould models Fi, Fj are defined, such that H(Fi)=1/2·[(1+β)·H(P′i)+(1−β)·H(P′j)] and H(Fj)=1/2·[(1−β)·H(P′i)+(1−β)·H(P′j)].

The mutation algorithm will now be described. In this case, it is a polynomial mutation algorithm. A mould model P′k of the parent population PP1′ is selected. The selection is carried out in a random manner. In a variant, the mould model P′k is selected according to predetermined parental selection criteria. A random root u ε [0; 1] is then generated. A crossover operator δ is then calculated. If u<0.5, then

$$δ = {( 2 v )}^{\frac{1}{{η}_{m} + 1}} - 1 ; otherwise , δ = 1 - {[ 2 ( 1 - v ) ]}^{\frac{1}{{η}_{m} + 1}} ,$$

where ηₘ=20, Θ_{c} being the mutation index. For each discriminating characteristic, H=NTUS, VTUS, αTUS or ETUS, a child mould model Fk is defined, such that H(Fk)=H (P′k)+(Hmax−Hmin)·δ, where Hmax and Hmin are, respectively, the upper and lower bounds of the constraint ranges of each discriminating characteristic H.

The mould models Fi of the child population PF1 generated in this way, together with the mould models P′i of the selected parent population PP1′ form an evaluation population PE1 of mould models Ei. In a variant, the evaluation population is composed solely of the mould models Fi of the child population PF1. The discriminating characteristics of each mould model Fi meet the predetermined constraints, which in this case are NTUS ε [6; 9], VTUS ε [0 cm³; 20 cm³], αTUS ε [0°; 360°] and ETUS ε [4 mm; 6 mm].

Step C: Determining the Performance Indicators

In a step 206, the performance indicators VTUS, LJI and LTUL of each mould model Ei of the evaluation population PE1 are then determined on the basis of the discriminating characteristics of each mould model Ei of the evaluation population PE1.

TABLE 4
discriminating characteristics and performance indicators of each mould
Ei of the evaluation population PE1

| Individual | NTUS | VTUS (cm³) | αTUS (°) | ETUS (mm) | VTUS (cm³) | LJI (mm) | LTUL (mm) |
|---|---|---|---|---|---|---|---|
| E11 = P′11 | 9 | 19.6 | 90.9 | 4 | 19.6 | 24.8 | 0 |
| E1 = P′1 | 8 | 18.8 | 313.1 | 4.9 | 18.8 | 19.9 | 0 |
| E7 = P′7 | 7 | 15.4 | 181.4 | 4.9 | 15.4 | 14.3 | 0 |
| E18 = P′18 | 9 | 2.6 | 12.4 | 4.2 | 2.6 | 8.6 | 0 |
| E13 = P′13 | 7 | 13.3 | 131.2 | 5.4 | 13.3 | 25.0 | 0 |
| E17 = P′17 | 7 | 11.5 | 52 | 5.1 | 11.5 | 17.7 | 0 |
| E2 = P′2 | 7 | 5.8 | 246 | 4.4 | 5.8 | 17.4 | 0 |
| E15 = P′15 | 8 | 11 | 229.1 | 5.9 | 11 | 42.9 | 0 |
| E4 = P′4 | 8 | 4.3 | 167.2 | 5.3 | 4.3 | 30.7 | 0 |
| E3 = P′3 | 8 | 3.2 | 347.5 | 5.6 | 3.2 | 30.2 | 0 |
| E21 = F21 | 8 | 11.0 | 230.3 | 6 | 11.0 | 25.3 | 0 |
| E22 = F22 | 7 | 11.5 | 50.8 | 5 | 11.5 | 25.1 | 0 |
| E23 = F23 | 7 | 13.7 | 129.7 | 5.4 | 13.7 | 15 | 0 |
| E24 = F24 | 8 | 2.8 | 349.0 | 5.6 | 2.8 | 18.7 | 0 |
| E25 = F25 | 7 | 5.3 | 250.3 | 4.4 | 5.3 | 16.6 | 0 |
| E26 = F26 | 7 | 15.9 | 177.1 | 4.9 | 15.9 | 28.3 | 8.2 |
| E27 = F27 | 9 | 3.2 | 11.5 | 4.2 | 3.2 | 18.7 | 0 |
| E28 = F28 | 9 | 19.0 | 91.8 | 4 | 19.0 | 10.1 | 0 |
| E29 = F29 | 8 | 18.7 | 311.0 | 4.9 | 18.7 | 18.8 | 4.1 |
| E30 = F30 | 8 | 4.4 | 169.3 | 5.3 | 4.4 | 21.4 | 0 |

Step D: Selection of the Mould or Moulds

Then, in a step 208, each performance indicator VTUS, LJI and LTUL is compared with a predetermined performance condition associated with each performance indicator. In this case, the predetermined conditions are VTUS ε [0 cm3; 20 cm3] and LJI=0 and LTUL=0.

None of the mould models Ei of the population PE1 has indicators VTUS, LJI and LTUL which meet the predetermined performance conditions. Therefore, none of the mould models Ei of the population PE1 is selected. Consequently, the moulds Ei of the population PE1 form the moulds Pi of a parent or initial population PP2. The mould models Pi of the population PP2 are also classified and selected, in a similar manner to the classification carried out for the mould models Pi of the population PP1 in step 202.

In a first classification sub-step, each mould model Pi of the population PP21 is classified. Thus each mould model Pi of the population PP2 is classified as a function of VTUS and of the first indicator LJI. FIG. 16 shows the mould models Pi of the population PP2 belonging to the plane VTUS=[0; 20], LJI=[0 cm³; 450 cm³] and LTUL=0 in a Pareto diagram with VTUS shown on the horizontal axis and LJI on the vertical axis. The mould models Pi of the population PP2 are then classified according to PO ranks of the Pareto optimality problem. The mould models Pi of the population PP2 corresponding to the set of solutions to the Pareto optimality problem are then selected in a similar manner to the selection carried out for the mould models Pi. The selected mould models Pi of the population PP2 forming the solutions to the Pareto optimality problem are the mould models E28=P28, E11=P11 for a PO rank of 1, E1=P1, E7=P7, E23=P23, E29=P29 for a PO rank of 2, E13=P13, E17=P17, E22=P22, E25=P25, E26=P26 for a PO rank of 3, E21=P21, E27=P27, E30=P30 for a PO rank of 4, E24=P24, E2=P2, E15=P15 for a PO rank of 5, E18=P18, E4=P4, E3=P3 for a PO rank of 6, E30=P30, E24=P24 for a PO rank of 7, and E3=P3, E4=P4 for a PO rank of 8.

In a second classification sub-step, the modified rank Rank* is determined from the PO rank and from performance conditions not met by each of the mould models Pi.

The PO rank and Rank* are concatenated with the data of Table 4 in Table 5 below.

TABLE 5
discriminating characteristics, performance indicators, PO rank and
Rank* of each mould model Pi of the parent population PP2.

| Individual | NTUS | VTUS (cm³) | αTUS (°) | ETUS (mm) | VTUS (cm³) | LJI (mm) | LTUL (mm) | PO rank | Rank* |
|---|---|---|---|---|---|---|---|---|---|
| E11 = P11 | 9 | 19.6 | 90.9 | 4 | 19.6 | 24.8 | 0 | 1 | 8 |
| E28 = P28 | 9 | 19.0 | 91.8 | 4 | 19.0 | 10.1 | 0 | 1 | 8 |
| E1 = P1 | 8 | 18.8 | 313.1 | 4.9 | 18.8 | 19.9 | 0 | 2 | 9 |
| E7 = P7 | 7 | 15.4 | 181.4 | 4.9 | 15.4 | 14.3 | 0 | 2 | 9 |
| E23 = P23 | 7 | 13.7 | 129.7 | 5.4 | 13.7 | 15 | 0 | 2 | 9 |
| E13 = P13 | 7 | 13.3 | 131.2 | 5.4 | 13.3 | 25.0 | 0 | 3 | 10 |
| E17 = P17 | 7 | 11.5 | 52 | 5.1 | 11.5 | 17.7 | 0 | 3 | 10 |
| E22 = P22 | 7 | 11.5 | 50.8 | 5 | 11.5 | 25.1 | 0 | 3 | 10 |
| E25 = P25 | 7 | 5.3 | 250.3 | 4.4 | 5.3 | 16.6 | 0 | 3 | 10 |
| E21 = P21 | 8 | 11.0 | 230.3 | 6 | 11.0 | 25.3 | 0 | 4 | 11 |
| E27 = P27 | 9 | 3.2 | 11.5 | 4.2 | 3.2 | 18.7 | 0 | 4 | 11 |
| E30 = P30 | 8 | 4.4 | 169.3 | 5.3 | 4.4 | 21.4 | 0 | 4 | 11 |
| E2 = P2 | 7 | 5.8 | 246 | 4.4 | 5.8 | 17.4 | 0 | 5 | 12 |
| E15 = P15 | 8 | 11 | 229.1 | 5.9 | 11 | 42.9 | 0 | 5 | 12 |
| E24 = P24 | 8 | 2.8 | 349.0 | 5.6 | 2.8 | 18.7 | 0 | 5 | 12 |
| E18 = P18 | 9 | 2.6 | 12.4 | 4.2 | 2.6 | 8.6 | 0 | 6 | 13 |
| E4 = P4 | 8 | 4.3 | 167.2 | 5.3 | 4.3 | 30.7 | 0 | 6 | 13 |
| E3 = P3 | 8 | 3.2 | 347.5 | 5.6 | 3.2 | 30.2 | 0 | 6 | 13 |
| E29 = P29 | 8 | 18.7 | 311.0 | 4.9 | 18.7 | 18.8 | 4.1 | 2 | 16 |
| E26 = P26 | 7 | 15.9 | 177.1 | 4.9 | 15.9 | 28.3 | 8.2 | 3 | 17 |

In a third classification sub-step, some of the mould models Pi of the population PP2 are then classified. In this case, half of the mould models Pi of the parent population PP2 having the lowest performance indicator Rank*, in other words the mould models P11, P28, P1, P7, P23, P13, P17, P22, P25 and P21, are selected. These mould models Pi form a selected parent population PP2′ of moulds Pi′.

Steps B and C are then repeated, generating a new modified or child population PF2 of moulds Fi by modifying at least one discriminating characteristic of at least one mould model Pi′ of the selected parent population PP2′, each discriminating characteristic meeting at least one predetermined constraint. Thus a new evaluation population PE2 is determined, composed of the moulds Fi of the new modified or child population PF2 and the moulds Ei of the selected parent population PP2′. As a general rule, the evaluation population PEk is composed of the moulds Pk′ of the selected parent population PPk′ and the moulds Fk of the modified or child population PFk.

If none of the mould models E1 of the population PE2 has indicators VTUS, LJI and LTUL which meet predetermined performance conditions, some of the mould models E1 of the population PE2 are classified and selected in order to generate a selected parent population PP3′, and steps B and C are repeated as before, this procedure continuing until a population PEn, comprising at least one mould model whose indicators meet the associated predetermined conditions, is obtained.

If the indicators of one or more models Ei meet the predetermined conditions, then, in a final step 210, the mould model or models of the evaluation population are selected on the basis of the performance indicator or indicators in the population PEn. In this case, the mould model or models Ei whose indicators meet all the predetermined performance conditions are selected.

If a plurality of mould models are selected on the basis of the performance indicators, the choice of the mould model to be selected is made on the basis of additional criteria, such as the largest number NTUS or the greatest thickness ETUS.

FIG. 4 shows schematically the mould 100 on which are positioned the elements 18′ for moulding the audible wear indicators 18 by the method according to the first embodiment of the invention. The indicators for the mould 100 are VTUS=13.0457 cm³ and LJI=LTUL=0, and therefore the predetermined performance conditions are met. The discriminating characteristics of the mould 100 are VTUS=13.0457 cm³, NTUS=6, αTUS=228.334° and ETUS=4.8 mm, each of which meets the associated predetermined constraint, i.e. NTUS ε [6; 9], VTUS ε [0 cm³; 20 cm³], αTUS ε [0°; 360°] and ETUS ε [4 mm; 6 mm].

A curing mould 102 for a Michelin Energy Saver tyre comprising audible wear indicators 18 is shown schematically in FIG. 17. The elements 18′ have been positioned in the mould using the method according to the first embodiment of the invention. For the mould 102, the predetermined constraints for each discriminating characteristic are NTUS ε [4; 8], VTUS ε [10 cm³; 20 cm³], αTUS ε [0′; 360°] and ETUS ε [3 mm; 4 mm]. In a similar way to the mould 100, the indicators for the mould 102 are VTUS=14.7241 cm³ and LJI=LTUL=0, and therefore the predetermined performance conditions are met. The discriminating characteristics of the mould 102 are VTUS=14.7241 cm³, NTUS=4, αTUS=65.2739° and ETUS=3.1 mm, each of which meets the associated predetermined constraint.

When the mould 100 of FIG. 4 has been selected, the mould is made by conventional mould manufacturing methods. When the mould 100 has been made, the tyre 10 is manufactured by curing a green blank in the mould 100.

A method according to a second embodiment will now be described, with reference to FIGS. 18 to 20. Elements similar to those shown in the preceding figures are denoted by identical references.

In this case, each wear indicator 18 is formed by a rubber rib 20 arranged transversely at the bottom of the groove 16 in which it is located, and extending radially from the bottom of this groove 16. When the tyre is new, each rib 20 has a predetermined height which is substantially equal to the difference between the depth of the grooves 16 and the predetermined threshold of radial wear. The ribs 20 are equally distributed circumferentially on the tyre 10. The tyre 10 comprises N=3 grooves 16.

Each rib 20 is separated circumferentially from each rib 40. In other words, the ribs 20 and 40 do not touch each other.

When the tyre 10 is new, as shown in FIG. 18, the height of the ribs 20, 40 is less than the depth of the grooves 16, and therefore each wear indicator 1, 38 comprises a space located above the ribs 20, 40, that is to say at the top of the ribs 20, 40. Thus, even when the tread is in contact with flat smooth ground, the ground does not come into contact with the ribs 40.

The ribs 20, 40 are arranged in such a way that, regardless of the radial wear on the tyre 10, circumferentially successive ribs 20, 40 of the same groove 16 and the groove 16 itself delimit a space which remains open to the air when they pass through the contact patch of the tyre 10 on the ground. Depending on the distribution of the wear indicators 18, 38, each pair of ribs 20, 40 in question comprises two ribs 20, two ribs 40 or one rib 20 and one rib 40. In this case, the distance between two circumferentially successive ribs 20, 40 of the same groove 16 is greater than a predetermined distance, which is the length of the contact patch in the present case, so that, even beyond the predetermined and/or legal threshold of radial wear, the ribs 20, 40 and the groove 16 form a space which remains open to the air when they pass through the contact patch of the tyre 10 on the ground.

FIG. 19 shows the tyre 10 of FIG. 18 which has been worn beyond the predetermined threshold of radial wear.

The wear on the tread 12 is greater than the predetermined threshold of radial wear; that is to say, it is greater than the distance separating the tops of the ribs 20 from the surface of the tread 12 when the tyre 10 is new. Because of this wear which is greater than the threshold, the tops of the ribs 20 are at the same level as the surface of the tread 12. The wear on the tread 12 is less than the legal threshold of wear; that is to say, it is less than the distance separating the tops of the ribs 40 from the surface of the tread 12 when the tyre 10 is new. The tops of the ribs 40 are at a lower level than the tread 12 at this stage of wear.

When the tyre 10 is worn beyond the predetermined threshold of radial wear, each rib 20 is shaped in such a way that it comes into contact with the ground during its passage through the contact patch of the tyre 10 on the ground. It then emits a sound.

A second embodiment of the method for designing a mould will now be described.

By contrast with the design method according to the first embodiment, each characteristic relating to the audible wear indicator 18 is chosen from the group comprising at least one characteristic relating to the number of wear indicators, in this case the total number NTUS of sets of wear indicators 18, at least one characteristic relating to the circumferential distribution of the wear indicators 18, in this case the equal distribution of the sets of wear indicators 18 and a reference position αTUS of one of the sets of wear indicators 18, and at least one characteristic relating to a dimension of each wear indicator, in this case the thickness ETUS in the circumferential direction of each rib 20.

By contrast with the method according to the first embodiment, a plurality of axially adjacent circumferential bands, in this case three bands B1, B2, B3, are determined on each mould model Ei of the evaluation population PE1, each band comprising a groove 16. Thus, each prohibited region ZI of each band B1-B3, and therefore of each groove 16, is defined. The regions ZTUL of each band B1-B3, and therefore of each groove 16, are also defined. Each band B1-B3 extends over the whole circumference of the model Ei.

Before step 206, an interpenetration indicator LJIp between each rib 20p of each wear indicator 18 and each prohibited region ZI is determined for each band B1-B3, together with an indicator LTULp of the overlapping of each wear indicator 38 with each rib 20p. Thus, if a tyre model Pi comprises two wear indicators 18p per set, and four sets, in other words NTUS=4, then eight interpenetration indicators LJIp and eight overlap indicators LTULp are determined, where p varies from 1 to 8.

The performance indicators of the method according to the second embodiment therefore comprise the interpenetration indicators LJIp between at least one rib 20p and each prohibited region ZI and an indicator LTULp of the overlapping of each legal wear indicator 38 with a rib 20p.

In step 208, each performance indicator LJIp and LTULp is compared with a predetermined performance condition associated with each performance indicator, in this case LJIp=0 and LTULp=0.

If, for each set of wear indicators 18, at least N1=2 interpenetration indicators LJIp meet the predetermined performance condition associated with the interpenetration indicator, in this case LJIp=0, and if the indicator LTULp also meets the predetermined performance condition associated with it, the model Ei is selected.

In a variant, N=2 and N1=1. In another variant, N=4 and N1=2.

The other characteristics of the method according to the second embodiment are identical, mutatis mutandis, to those of the method according to the first embodiment.

FIG. 20 shows schematically the mould 100 on which are positioned the elements 18′ for moulding the audible wear indicators 18 by the method according to the second embodiment of the invention. The indicators for the mould 100 are LJIp=LTULp=0, and therefore the predetermined performance conditions are met. The discriminating characteristics of the mould 100 are NTUS=8, αTUS=104.13° and ETUS=4.85 mm, each of which meets the associated predetermined constraint, i.e. NTUS ε [6; 9], αTUS ε [0°; 360°] and ETUS ε [4 mm; 6 mm]. The mould comprises elements for moulding two sets of three wear indicators 18, in which the wear indicators are positioned in the bands B1, B2 and B3, and six sets of two wear indicators 18, in which the wear indicators 18 are positioned in the bands B1 and B2 in one case and in the bands B2 and B3 in the other five cases.

A tyre and a method according to a third embodiment of the invention will now be described with reference to FIGS. 21 to 23. Elements similar to those shown in the preceding figures are denoted by identical references.

By contrast with the tyre according to the first embodiment, each legal wear indicator is adjacent to a rib 20 of each wear indicator 18. With reference to FIGS. 21 and 22, which show the tyre 10 according to the third embodiment with a degree of wear corresponding to the predetermined threshold of radial wear, the two wear indicators 18 and 38 thus form a single wear indicator comprising, and in this case composed of, two ribs 42, 44 arranged at the bottom of the groove 16. The rib 42 has a generally stepped shape and comprises first and second rubber parts 46, 48 forming, respectively, one of the ribs 20 of the wear indicator 18 and the rib 40 of the wear indicator 38. The rib 44 forms the other rib 20 of the wear indicator 18.

A third embodiment of the method for designing a mould will now be described.

By contrast with the method according to the first embodiment, the discriminating characteristics comprise characteristics relating to the dimensions of each wear indicator. These characteristics comprise the thickness ETUS1 in the circumferential direction of the rib 42 and the thickness ETUS2 in the circumferential direction of the rib 44. The constraint range of ETUS1 is [5 mm; 7 mm], in order to take the rib 40 into consideration, and that of ETUS2 is [2 mm; 4 mm]. Additionally, the indicator of inclusion of the legal wear indicators in a sounding cavity is removed.

Additionally, by contrast with the method according to the first embodiment, and in a similar way to the method according to the second embodiment, a plurality of circumferential bands, in this case three bands B1, B2, B3, each band comprising a groove 16, are determined on each mould model Ei of the evaluation population PE1. Thus, each prohibited region ZI of each band B1-B3, and therefore of each groove 16, is defined. The regions ZTUL of each band B1-B3, and therefore of each groove 16, are also defined.

Then, before step 206, an interpenetration indicator LJIp between each rib 20p of each wear indicator 18 and each prohibited region ZI is determined for each band B1-B3, together with an indicator LTULp of the inclusion of each wear indicator 38 in each sounding cavity 22p.

The other characteristics of the method according to the third embodiment are identical, mutatis mutandis, to those of the method according to the first and second embodiment.

FIG. 23 shows schematically the mould 100 on which are positioned the elements 18′ for moulding the audible wear indicators 18 by the method according to the second embodiment. The indicators for the mould 100 are LJIp=LTULp=0, and therefore the predetermined performance conditions are met. The discriminating characteristics of the mould 100 are NTUS=5, αTUS=264.96° and ETUS1=5.76 mm and ETUS2=2.76 mm, each of which meets the associated predetermined constraint, i.e. NTUS ε [6; 9], VTUS ε [0 cm³; 20 cm³], αTUS ε [0°; 360°] ETUS1 ε [5 mm; 7 mm] and ETUS2 ε [2 mm; 4 mm]. Each set comprises two wear indicators 18. The mould 100 comprises three sets in which the wear indicators 18 are positioned in the bands B1 and B3, and two sets in which the wear indicators 18 are positioned in the bands B1 and B2. Additionally, the circumferential order of each rib 42, 44 may vary from one wear indicator to another.

A tyre and a method according to a fourth embodiment of the invention will now be described with reference to FIG. 24. Elements similar to those shown in the preceding figures are denoted by identical references.

By contrast with the tyre according to the second embodiment, each rib 20 of each wear indicator 18 is adjacent to a rib 40 of a wear indicator 38. With reference to FIG. 24, which show the tyre according to the fourth embodiment with a degree of wear corresponding to the predetermined threshold of radial wear, the two wear indicators 18 and 38 thus form a single wear indicator comprising, and in this case composed of, a single rib 50 arranged at the bottom of the groove 16. The rib 50 has a generally stepped shape and comprises first and second rubber parts 52, 54 forming the ribs 20, 40 respectively.

By contrast with the method according to the second embodiment, the constraint range of ETUS is [7 mm; 9 mm], in order to take the rib 40 into consideration.

The other characteristics of the method according to the fourth embodiment are identical, mutatis mutandis, to those of the methods according to the second and third embodiments.

The present invention is not limited to the embodiment described above.

Indeed, the method according to the invention is not limited to the mould for a tyre or to the tyre for a passenger vehicle. The invention is applicable to moulds and tyres for vehicles of any type, such as heavy goods vehicles, aircraft, two-wheeled vehicles, or civil engineering vehicles.

Additionally, although the design method described above is applicable to populations of mould models, the invention can also be used by applying steps A to D to populations of tyre models. In the present case, when the tyre 100 has been selected, the mould 100 is deduced from the tyre 10, by reverse engineering for example, and the tyre 10 is manufactured by curing a green blank in the mould 100.

The whole method according to the invention or any part thereof may be applied by using instructions in code capable of causing the steps of the method to be executed when it is run on a computer. The instructions may originate from computer programs recorded on a data recording medium such as a hard disc, a flash memory, a CD, or a DVD. It is possible to arrange for a program of this type to be made available for downloading from a telecommunications network such as the Internet or a wireless network. Updates of the program can thus be sent by the network to the computers connected thereto.

It should be noted that the characteristics of the different embodiments can be combined with each other, since they are mutually compatible.

It is also possible to envisage audible wear indicators of types other than those described above. Thus it is possible to provide an audible wear indicator which combines the effects of the first and third embodiments and comprises a rib including a sounding cavity arranged within the rib itself.

1: Method for designing a curing mould (100) for a tyre (10) comprising at least one audible wear indicator (18), characterized in that it includes the following steps A to D:
A—an initial population (PP) is defined, comprising at least one mould model (Pi) having at least one characteristic (VTUS, NTUS, αTUS, ETUS) relating to the wear indicator (18),
B—a modified population (PF) is generated, comprising at least one mould model (Fi) having at least one characteristic (VTUS, NTUS, αTUS, ETUS) relating to the wear indicator (18) produced by modifying at least one characteristic (VTUS, NTUS, αTUS, ETUS) of at least one mould model (Pi) of the initial population (PP),
C—at least one performance indicator (NTUS, VTUS, LJI, LTUL) is determined for each mould model (Ei) of an evaluation population (PE1) comprising at least one mould model (Fi) of the modified population (PF), based on at least one characteristic (VTUS, NTUS, αTUS, ETUS) of each mould model of the evaluation population (PE1),
D—one or more mould models (Ei) of the evaluation population (PE1) are selected on the basis of the performance indicator or indicators (NTUS, VTUS, LJI, LTUL).

2: Method according to claim 1, wherein each wear indicator (18) comprises a sounding cavity (22) shaped in such a way that, beyond a predetermined threshold of radial wear, the sounding cavity (22) opens radially towards the outside of the tyre (10) and is shaped so as to be closed in an airtight manner by the ground during its passage through the contact patch of the tyre (10) on the ground.

3: Method according to claim 2, wherein each characteristic (VTUS, NTUS, αTUS, ETUS) relating to the audible wear indicator (18) is chosen from a group comprising at least one characteristic relating to the number of wear indicators (NTUS); at least one characteristic relating to the total volume of the cavities (VTUS), the volume of each sounding cavity (22) being defined when the predetermined threshold of radial wear is reached; at least one characteristic relating to the circumferential distribution of the wear indicators (αTUS); and at least one characteristic relating to a dimension of each wear indicator (ETUS).

4: Method according to claim 3, wherein the characteristics relating to the circumferential distribution comprise the equal distribution of the wear indicators and a reference positioning angle (αTUS) of at least one wear indicator.

5: Method according to claim 3, wherein each wear indicator (18) comprises two ribs (20) arranged at the bottom of a groove (16) in the tyre, and the characteristic relating to the dimension comprises the thickness (ETUS) of each rib (20) of each wear indicator (18) measured in the circumferential direction.

6: Method according to claim 2, wherein the performance indicator or indicators (NTUS, VTUS, LJI, LTUL) are determined on the basis of the total volume (VTUS) of the sounding cavities (22).

7: Method according to claim 2, wherein each wear indicator (18) comprises two ribs (20) arranged at the bottom of a groove (16) in the tyre (10), and the performance indicator or indicators (NTUS, VTUS, LJI, LTUL) are determined on the basis of at least one indicator (LJI) of interpenetration between each rib (20) and at least one predetermined region (ZI) of the mould model (100), called the prohibited region.

8: Method according to the claim 7, wherein a plurality of axially adjacent circumferential bands are determined in each mould model (Ei) of the evaluation population (PE1), and for each band (B1-B3) at least one indicator of interpenetration between each rib (20) and each prohibited region (ZI) is determined.

9: Method according to claim 7, wherein the mould model (100) comprises a plurality of distinct matrices (A, B, C, U) for moulding distinct (A′, B′, C′, U′) circumferential portions of the tyre (10), and the prohibited regions (ZI) comprise two end regions of each matrix (A, B, C, U).

10: Method according to claim 7, wherein the prohibited region (ZI) comprises a region through which a moulding blade of a sculpture element (30A-30C) passes, such that a sounding cavity (22) located in the corresponding prohibited region (ZI′) of the tyre (10) is not closed in an airtight manner by the ground during its passage through the contact patch of the tyre (10) on the ground.

11: Method according to claim 2, wherein the tyre (10) comprises a legal wear indicator (38), and the performance indicator or indicators (NTUS, VTUS, LJI, LTUL) are determined on the basis of at least one indicator (LTUL) of the inclusion of at least one legal wear indicator (38) in at least one sounding cavity (22).

12: Method according to claim 11, wherein a plurality of axially adjacent circumferential bands are determined in the mould model, and, for each band (B1-B3), at least one indicator of inclusion of each legal wear indicator (38) in each sounding cavity (22) is determined.

13: Method according to claim 1, wherein each wear indicator comprises a rib (20) extending radially from the bottom of a circumferential groove (16) of the tyre (10) and arranged so as to come into contact with the ground during its passage through the contact patch of the tyre (10) on the ground beyond a predetermined threshold of radial wear of the tyre (10).

14: Method according to claim 13, wherein the ribs (20) are arranged in such a way that, regardless of the wear on the tyre, two circumferentially successive ribs (20) of the same groove (16) and the groove (16) itself delimit a space which remains open to the air when the two ribs (20) pass through the contact patch of the tyre (10) on the ground.

15: Method according to claim 13, wherein each characteristic (NTUS, αTUS, ETUS) relating to the audible wear indicator (18) is chosen from the group comprising at least one characteristic relating to the number of wear indicators (NTUS), at least one characteristic relating to the circumferential distribution of the wear indicators (αTUS) and at least one characteristic relating to a dimension of each wear indicator (ETUS).

16: Method according to claim 15, wherein the characteristics relating to the circumferential distribution comprise the equal distribution of the wear indicators and a reference positioning angle (αTUS) of at least one wear indicator.

17: Method according to claim 15, wherein the characteristic relating to the dimension comprises the thickness (ETUS) of each rib (20) of each wear indicator (18) measured in the circumferential direction.

18: Method according to claim 13, wherein the performance indicator or indicators (NTUS, LJI, LTUL) are determined on the basis of at least one indicator (LJI) of interpenetration between each rib (20) and at least one predetermined region (ZI) of the mould model (100), called the prohibited region.

19: Method according to claim 18, wherein a plurality of axially adjacent circumferential bands are determined in each mould model, and for each band (B1-B3) at least one indicator of interpenetration between each rib (20) and each prohibited region (ZI) is determined.

20: Method according to claim 18, wherein the mould model (100) comprises a plurality of distinct matrices (A, B, C, U) for moulding distinct circumferential portions (A′, B′, C′, U′) of the tyre (10), and the prohibited regions (ZI) comprise two end regions of each matrix (A, B, C, U).

21: Method according to claim 13, wherein the tyre (10) comprises a legal wear indicator (38), and the performance indicator or indicators (NTUS, LJI, LTUL) are determined on the basis of at least one indicator (LTUL) of the overlapping of at least one legal wear indicator (38) with a rib (20).

22: Method according to claim 21, wherein a plurality of axially adjacent circumferential bands are determined in each mould model (Ei) of the evaluation population (PE1), and for each band (B1-B3) at least one indicator of overlapping between each legal wear indicator (38) and each rib (20) is determined.

23: Method according to claim 22, wherein each mould model (Ei) of the evaluation population (PE1) is selected if, in this model, each performance indicator (NTUS, VTUS, LJI, LTUL) meets a predetermined performance condition associated with the performance indicator (NTUS, VTUS, LJI, LTUL).

24: Method according to claim 7, wherein the tyre comprises N grooves (16), where N>1, and comprises a plurality of sets of wear indicators (18) equally distributed circumferentially, the wear indicators (18) of each set being substantially aligned axially with one another, while each mould model (Ei) of the evaluation population (PE1) is selected if, in this model, for each set, at least a number N1 of interpenetration indicator(s) (LJIp) meet a predetermined performance condition associated with the interpenetration indicator (LJIp) with N<N1.

25: Method according to claim 1, wherein, after step A and before step B, the mould models (Pi) of the initial population (PP) are classified, and part of the initial population (PP′) is selected.

26: Method according to claim 1, wherein, as long as every indicator fails to meet a predetermined performance condition, steps B and C are repeated, thereby generating a new population (PEn) modified by at least one modification of at least one characteristic (VTUS, NTUS, αTUS, ETUS) of at least one mould model (Ei) of the evaluation population (PE1, PE2, PEk) forming a new initial population.

27: Method according to claim 26, wherein the mould models (Ei) of the evaluation population (PE1, PE2, PEk) are classified, and part of the evaluation population (PE1′, PE2′) is selected, the selected part (PE1′, PE2′) of the evaluation population (PE1, PE2) then forming at least a part of the new initial population.

28: Method according to claim 1, wherein each characteristic (VTUS, NTUS, αTUS, ETUS) of each model of the initial population and/or of the modified population and/or of the evaluation population meets at least one predetermined constraint.

29: Method for designing a tyre (10) comprising at least one audible wear indicator (18), characterized in that it includes the following steps A to D:
A—an initial population is defined, comprising at least one tyre model having at least one characteristic (VTUS, NTUS, αTUS, ETUS) relating to the wear indicator (18),
B—a modified population is generated, comprising at least one tyre model having at least one characteristic (VTUS, NTUS, αTUS, ETUS) relating to the wear indicator (18) produced by modifying at least one characteristic (VTUS, NTUS, αTUS, ETUS) of at least one tyre model of the initial population,
C—at least one performance indicator (NTUS, VTUS, LJI, LTUL) is determined for each tyre model of an evaluation population comprising at least one tyre model of the modified population, based on at least one characteristic (VTUS, NTUS, αTUS, ETUS) of each tyre model of the evaluation population,
D—one or more tyre models of the evaluation population are selected on the basis of the performance indicator or indicators.

30: Computer program, characterized in that it comprises instructions in code capable of causing the steps of claim 1 to be executed when the program is run on a computer.

31: Data recording medium comprising, in recorded form, a program according to claim 30.

32: Method for manufacturing a curing mould (100) for a tyre, characterized in that a method according to claim 1 is used, and the mould is made from one of the selected models.

33: Method for manufacturing a mould (100), characterized in that a method according to claim 29 is used, the mould is deduced from one of the selected tyres, and the mould is made.

34: Curing mould (100) for a tyre, characterized in that the mould is manufactured using a method according to claim 32.

35: Method for manufacturing a tyre, characterized in that a mould (100) is manufactured using a method according to claim 32 and a green blank is cured in the mould (100).

36: Tyre, characterized in that the tyre is manufactured using a method according to claim 35.
